(19) United States
(12) Patent Application Publication
(10) Pub. No.: US 2019/0188806 A1
(43) Pub. Date: Jun. 20, 2019

(54) Business-Oriented Social Network Employing Recommendations and Associated Weights

(71) Applicant: Torre Technologies Co., San Francisco, CA (US)

(72) Inventors: Alex Henriquez Torrenegra, San Francisco, CA (US); Amaury Prieto, Bogota (CO); Daniela Avila Gomez, Bogota (CO); David Camargo, Bogota (CO); Manuel Montes, Bogota (CO); Ana Maria Diaz, Bogota (CO); David Montaño, Bogota (CO); Rodrigo Herrero, Armenia (CO)

(73) Assignee: Torre Technologies Co., San Francisco, CA (US)

(21) Appl. No.: 16/226,030

(22) Filed: Dec. 19, 2018

Related U.S. Application Data
(60) Provisional application No. 62/608,153, filed on Dec. 20, 2017.
(60) Provisional application No. 62/661,988, filed on Apr. 24, 2018.

(51) Int. Cl. G06Q 50/00; G06Q 10/06; H04L 29/08; G06F 17/11

(52) U.S. Cl. CPC G06Q 50/01; G06F 17/11; H04L 67/306; G06Q 10/06398

(57) ABSTRACT

A computer-implemented method and system is provided that involves a plurality of users of a social network. The method and system are configured to interact with the plurality of users to generate recommendations, wherein each recommendation is made by a first user and recommends a second user, and store data representing the recommendations. Total recommendation weights corresponding to the plurality of users as well as recommendation weights corresponding to the recommendations are dynamically calculated, and data representing the total recommendation weights corresponding to the plurality of users and data representing the recommendation weights corresponding to the recommendations is stored in data storage. Data representing the total recommendation weight corresponding to a given user can be displayed in conjunction with the display of at least part of a profile of the given user. A representation of a given recommendation and data representing the recommendation weight corresponding to the given recommendation can be displayed together. Other features and aspects are described and claimed.

### CROSS-REFERENCE TO RELATED APPLICATION(S)

The present disclosure claims priority from U.S. Provisional Appl. No. 62/608,153, filed on Dec. 20, 2017 and from U.S. Provisional Appl. No. 62/661,988, filed on Apr. 24, 2018, both incorporated by reference herein in their entireties.

### BACKGROUND

### 1. Field

The present disclosure relates to business-oriented social networks.

### 2. State of the Art

A social network can be implemented as an online service, platform or site that allows users to build or reflect social networks or social relations among users of the social network. Typically, users construct profiles, which may include personal information such as name, contact information, employment information, photographs, personal messages, status information, links to web-related content, blogs, and so on. Typically, only a portion of a user's profile may be viewed by the general public and/or by other users.

The social network allows users to identify and establish connections with other users in order to build or reflect relations among users.

A business-oriented social network is a type of social network that allows users to establish a connection with his or her business contacts, including work colleagues, clients, customers, and so on. A connection is generally formed using an invitation process in which one user “invites” a second user. The second user than has the option of accepting or declining the invitation.

In the context of business-oriented social networks, users may often specify a list of their professional experiences as part of their member profiles. Such professional experiences can include past and/or present jobs, projects, educational degrees or certificates, interests, skills, and/or other experiences. Note that other users, businesses and advertisers can use these professional experiences to qualify a user or find users based on some target criteria. The inherent problem with using user-submitted professional experiences is that they are entirely subjective and prone to fraud. Thus, a user may present him or herself as having a professional experience that the user does not possess or that did not occur. Furthermore, even though a user may arguably possess a certain skill, there is no indication that the user is in fact proficient in that skill.

### SUMMARY

A computer-implemented method is provided that involves a plurality of users of a social network, which includes interacting with the plurality of users to generate recommendations, wherein each recommendation is made by a first user and recommends a second user, and storing data representing the recommendations. Total recommendation weights corresponding to the plurality of users as well as recommendation weights corresponding to the recommendations are dynamically calculated, and data representing the total recommendation weights corresponding to the plurality of users and data representing the recommendation weights corresponding to the recommendations is stored in data storage. Data representing the total recommendation weight corresponding to a given user can be displayed in conjunction with the display of at least part of a profile of the given user. A representation of a given recommendation and data representing the recommendation weight corresponding to the given recommendation can be displayed together.

In embodiments, the representation of a given recommendation and the data representing the recommendation weight corresponding to the given recommendation can be displayed in conjunction with displaying at least part of a profile of the second user of the given recommendation. Additionally or alternatively, the representation of a given recommendation and the data representing the recommendation weight corresponding to the given recommendation can be displayed in conjunction with displaying at least part of a profile of the first user of the given recommendation.

In embodiments, the recommendation weight for a given recommendation can be based on the total recommendation weight of the first user of the given recommendation. Additionally or alternatively, the recommendation weight for a given recommendation can be based on a longevity parameter that characterizes time duration of the relation between the first user and second user of the given recommendation. Additionally or alternatively, the recommendation weight for a given recommendation is based on a factor dictated by type of relation between the first user and second user of the given recommendation. Additionally or alternatively, the recommendation weight for a given recommendation is normalized by a sum corresponding to the total number of recommendations made by the first user of the given recommendation.

In embodiments, the recommendation weight for a given recommendation can be of the form:

$${w}_{r} ( X 1 , Y ) = \frac{t ( X 1 ) {L}_{X 1 , Y} {F}_{X 1 , Y}}{{\sum }_{i = 0}^{n} {( {L}_{i} {F}_{i} )}_{X 1}}$$

where X1 denotes the user giving the given recommendation and Y denotes the user receiving the given recommendation,
t(X1) is the total recommendation weight of X1;

L_{X1,Y} is a longevity factor that depends on the time duration of the relation between X1 and Y;
F_{X1,Y} is a factor associated with the type of relation between X1 and Y; and
the summation Σᵢ₌₀ⁿ (LᵢFᵢ)_{X1} corresponds to the total number of recommendations made by X1, and more specifically adds the multiplication product of the longevity factors and relation type factors for all the recommendations given by X1.

In embodiments, the total recommendation weight for a given user can be calculated from the sum of the recommendation weights for all recommendations received by the given user.

In embodiments, the total recommendation weight for a given user can be of the form:

t(Y)=β(wᵣ(X1, Y)+ . . . wᵣ(Xn, Y))
where Y is the given user recommended by a number of other users denoted X1 . . . Xn;
β is a damping factor constant in the interval [0,1], which limits the extent in which the User Y′s total recommendation weight will be inherited by its recommendations; and
the sum wᵣ(X1, Y)+ . . . wᵣ (Xn, Y) represents the sum of all the recommendations weights for the recommendations that the given User Y has received.

In embodiments, the recommendation weight corresponding to a given recommendation can provide a measure of trustworthiness of the given recommendation, and the total recommendation weight corresponding to a given user can provide a measure of trustworthiness of the given user.

In embodiments, the method can further include operations that are of generating the recommendations, where such operations involve interacting with the first user of a given recommendation to specify a set of experiences of the second user that are associated with the given recommendation, and storing data representing the set of experiences of the second user that are associated with the given recommendation. The method can further include calculating per-experience recommendation weights for the set of experiences of the second user that are associated with the given recommendation, and storing data representing the per-experience recommendation weights for the set of experiences of the second user that are associated with the given recommendation.

In embodiments, the per-experience recommendation weights for the set of experiences of the second user that are associated with the given recommendation can be calculated by distributing the recommendation weight corresponding to the given recommendation.

In embodiments, the method can further include calculating a total per-experience weight for at least one particular experience of a given user by summing the per-experience recommendation weights for the particular experience that corresponds to all recommendations received by the given user, and storing data representing the total per-experience weight for the at least one particular experience of the given user.

In embodiments, data representing the total per-experience weight for at least one particular experience of the users can be used to rank users that match a particular job posting or users that are interested in a particular job posting. Additionally or alternatively, data representing the total recommendation weights of users can be used to rank users that match a particular job posting or users that are interested in a particular job posting.

In embodiments, the method can store user profile data for the plurality of users of the social network in a distributed ledger. The user profile data stored in the distributed ledger can include the data representing the total recommendation weights corresponding to the plurality of users and the data representing the recommendation weights corresponding to the recommendations. Alternatively, the data representing the total recommendation weights corresponding to the plurality of users and the data representing the recommendation weights corresponding to the recommendations can be stored in a side chain or aux chain or other data store.

In embodiments, the user profile data stored in the distributed ledger can be based upon requests that include digital signatures derived from private encryption keys of the users. In this case, each request can be validating by verifying the digital signature included in the request against a public encryption key of the corresponding user. Such public encryption key can be preferably stored as publicly available data in the distributed ledger.

In embodiments, the calculation of total recommendation weights corresponding to the plurality of users as well as the calculation of the recommendation weights corresponding to the recommendations can be performed by at least one node of the social network in response to a request that adds or updates a recommendation for a user. The at least one node can be configured to perform a set of actions that adds or updates user profile data of a user in response to requests supplied thereto.

In embodiments, the social network can include wallet functionality that is configured to store a private encryption key for each respective user and use the private encryption key to digitally sign requests issued by the user to add or update user profile data of the user.

In yet another aspect, a social network system (such as system for a business-oriented social network) can employ at least one computer processor configured to include:
at least one module configured to interact with a plurality of users of a social network to generate recommendations, wherein each recommendation is made by a first user and recommends a second user, and
at least one module configured to dynamically calculate total recommendation weights corresponding to the plurality of users as well as recommendation weights corresponding to the recommendations.
   The system can further include data storage configured to store data representing the total recommendation weights corresponding to the plurality of users and data representing the recommendation weights corresponding to the recommendations.

In embodiments, the at least one computer processor of the system can be further configured to include at least one module configured to present for display data representing the total recommendation weight corresponding to a given user in conjunction with displaying at least part of a profile of the given user. Additionally or alternatively, the at least one computer processor of the system can be further configured to include at least one module configured to present for display a representation of the given recommendation and data representing the recommendation weight corresponding to the given recommendation.

In embodiments, the at least one computer processor of the system can be configured to include modules that perform other parts of the method as described and claimed in the present disclosure.

In other aspects, parts or all of the methods as described and claimed in the present disclosure can be embodied in a machine or computer readable storage medium including instructions, which when executed on the machine or computer, cause the machine or computer to carry out such method steps.

This summary is intended to provide an overview of subject matter of the present disclosure. It is not intended to provide an exclusive or exhaustive explanation of the inventions described herein. The detailed description is included to provide further information about the present disclosure.

### BRIEF DESCRIPTION OF THE DRAWINGS

FIG. 1 is a flowchart illustrating one example method of the present disclosure.

FIG. 2 is a schematic illustration of a recommendation and associated data.

FIGS. 3A and 3B, collectively, is a flowchart of one example method where one user (source user) verifies a target user and submits and possibly edits or deletes a recommendation for the target user and associated data.

FIG. 4A to 4D are graphs that illustrate example weight update methods.

FIG. 5 is a schematic illustration of an example business-oriented social network.

FIG. 6 is a diagram of an example data schema for storing user profile data as well as data for recommendations and associated recommendation weights.

FIGS. 7 to 16 are screen captures (e.g., display screens) of example user interfaces that are presented by the social network for display on user computer systems and implement operations of the present disclosure.

FIGS. 17A and 17B are schematic illustrations of embodiments that extend the method of FIG. 1 for job recruiting applications.

FIG. 18 is a schematic view of a decentralized business-oriented social network and workflow in accordance with an aspect of this disclosure.

FIG. 19A is a schematic view of an exemplary network of ledger nodes that can be part of the decentralized business-oriented social network of FIG. 18.

FIG. 19B is a schematic view of an exemplary distributed ledger (blockchain) that can be maintained by the network of ledger nodes of FIG. 19A.

FIG. 20 is a schematic view of an example computer system.

### DETAILED DESCRIPTION OF THE PREFERRED EMBODIMENTS

In the following, a detailed description of examples will be given with references to the drawings. It should be understood that various modifications to the examples may be made. In particular, elements of one example may be combined and used in other examples to form new examples.

Many of the examples described herein are provided in the context of a business-oriented social networking website or service. However, the applicability of the inventive subject matter is not limited to business-oriented social networking websites or platforms.

As used herein, a “strength” of a person or user shall mean a particular skill or specialty or talent or other attribute or quality possessed by the person.

As used herein, an “experience” of a person or user shall mean a past or present job or position of the person, a title for a job or position of the person, a project that the person is contributing to (or has contributed to), an educational degree or certificate earned by the person, an interest of the person, a strength of the person, an organization or club that the person participates in or belongs to, and/or other experiences that relate to the person's profession(s) or occupation(s) over time.

As used herein, a “recommendation” of a person or user shall mean an action where one person (the “recommender”) recommends or endorses another person (the “recommended”). It is contemplated that the recommender can associate zero or more strengths or other experiences of the recommended that is part of the profile of the recommended with the recommendation so as to convey a basis for the recommendation.

The present disclosure describes a method for defining recommendations between users of a business-oriented social network and for calculating recommendation weights or scores that are associated with the recommendations. Each recommendation involves two users, which are referred to as the “recommender” and the “recommended.” The recommender is the user making the recommendation. The recommended is the user that is receiving the recommendation. The recommendation weight for a given recommendation is calculated from the total recommendation weight of the recommender and a longevity parameter that characterizes the time duration of the relation between the recommender and the recommended. The total recommendation weight for the recommender is calculated from the sum of the recommendation weights for all recommendations received by the recommender. The recommendation weight associated with a given recommendation can provide a measure of trustworthiness of the given recommendation as a recommendation with a relatively higher recommendation weight comes from a user that has been more highly recommended by other users. Moreover, the recommendation weight associated with a given recommendation can be distributed amongst one or more strengths or other experiences of the recommended specified by the recommender to derive a set of per-strength (or per-experience) recommendation weights associated with a given recommendation. Each per-strength (or per-experience) recommendation weight can provide a measure of trustworthiness of the corresponding strength (or experience) specified by the recommender as part of the recommendation. Furthermore, the total recommendation weight for a user can provide a measure of trustworthiness of the user as a user with a relatively higher total recommendation weight has been more highly recommended by other users. In this manner, the recommendation weights for the recommendations received by a user, the per-strength (or per-experience) recommendation weights associated therewith, and the total recommendation weight of the user can add measures of trustworthiness (and truthfulness) to the profile of the user. Other users can use these measures of trustworthiness and truthfulness in evaluating the trustworthiness and/or truthfulness of the professional experiences that the user has listed in his or her profile.

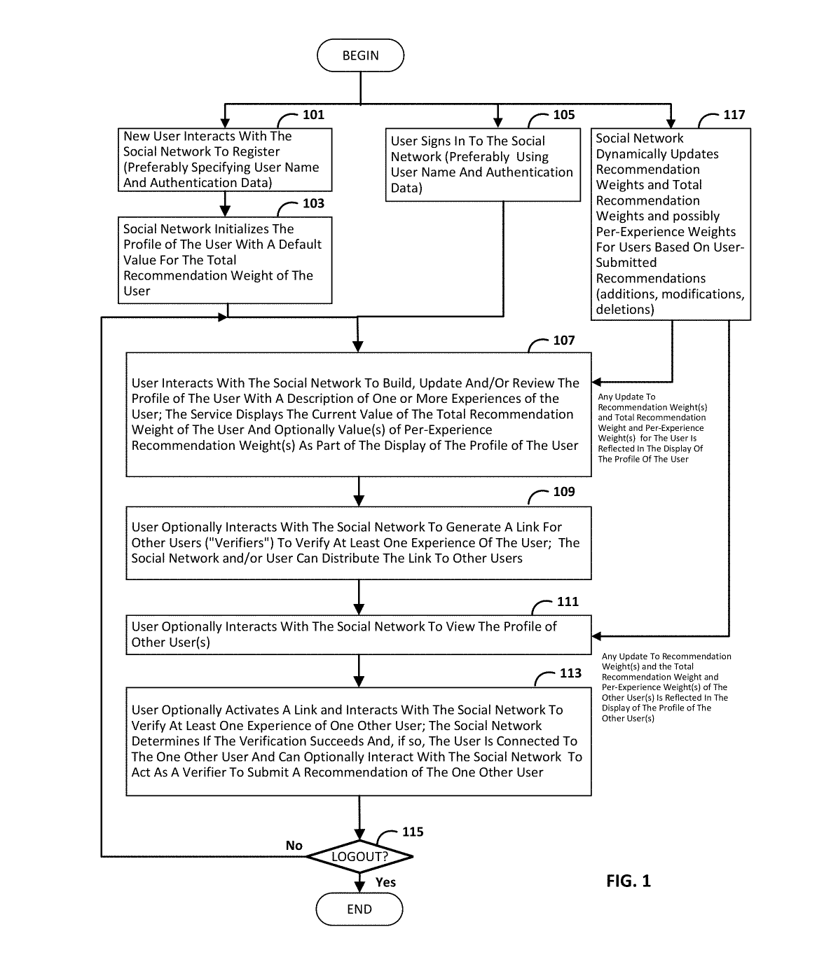

FIG. 1 presents a high-level view of a method implemented as part of business-oriented social network according to one example implementation.

In step 101, a new user interacts with the social network to register with the social network, which can involve the new user specifying a username and authentication mechanism such as password or other form of authentication (e.g., fingerprint, voice and/or facial verification on a mobile device or two-factor authentication methods).

In step 103, the profile of the user is initialized with a default value for the total recommendation weight of the user, and the operations continue to steps 107 to 115. For example, in one embodiment, the default value for the total recommendation weight of the user can be zero. And once the user is verified by another user of the social network, the total recommendation weight of the user can be adjusted to another predefined value, such as a value of 100.

In step 105, a user interacts with the social network to sign in to the social network preferably using the username and authentication mechanism specified by the user in the registration step 101, and the operations continue to steps 107 to 115.

In step 107, the user interacts with the social network to build, update and/or review the profile of the user with a description of one or more experiences of the user. The social network can be configured to present for display the current value of the total recommendation weight of the user and optionally value(s) of one or more per-experience recommendation weight(s) as part of the display of the profile of the user

In step 109, the user optionally interacts with the social network to generate a link for other users (“verifiers”) to verify at least one experience of the user. The social network and/or user can distribute the link to other users.

In step 111, the user optionally interacts with the social network to view the profile of other user(s).

In step 113, the user optionally activates a link and interacts with the social network to verify at least one experience of one other user. The social network can determine if the verification succeeds. If so, the user is connected to the one other user and can optionally interact with the social network to act as a verifier to submit a recommendation of the one other user at the discretion of the user.

In alternate embodiments, steps 109 to 113 can be adapted to use a link or other interface to enable the user to interact with the social network to act as a recommender to submit a recommendation of the one other user at the discretion of the user.

In step 115, the social network determines if the user has logged off (or otherwise terminated its session with the social network). If not, the operations of steps 107 to 115 can continue. If so, the user's access is terminated and subsequent access to the social network (steps 107 to 113) requires another user login (step 105).

In step 117, the social network uses the recommendations submitted by users (“recommenders”) to dynamically update the recommendation weight(s) and the total recommendation weight and optionally per-experience recommendation weight(s) for the users of the social network. As a result of this process, any update to the recommendation weight(s) and the total recommendation weight and per-experience recommendation weight(s) for a given user is reflected in the profile of the given user and its display in steps 107 and 111.

Note that although the operations of steps 101 to 115 are described for a single user, these operations can be performed by multiple users of the social network whereby the multiple users access the social network in a sequential manner or in parallel with one another. Also note that other potential actions can be provided by the social network in conjunction with a user's access to the social network. For example, the social network can possibly provide messaging or other forms of communication between users and presentation of advertisements to users.

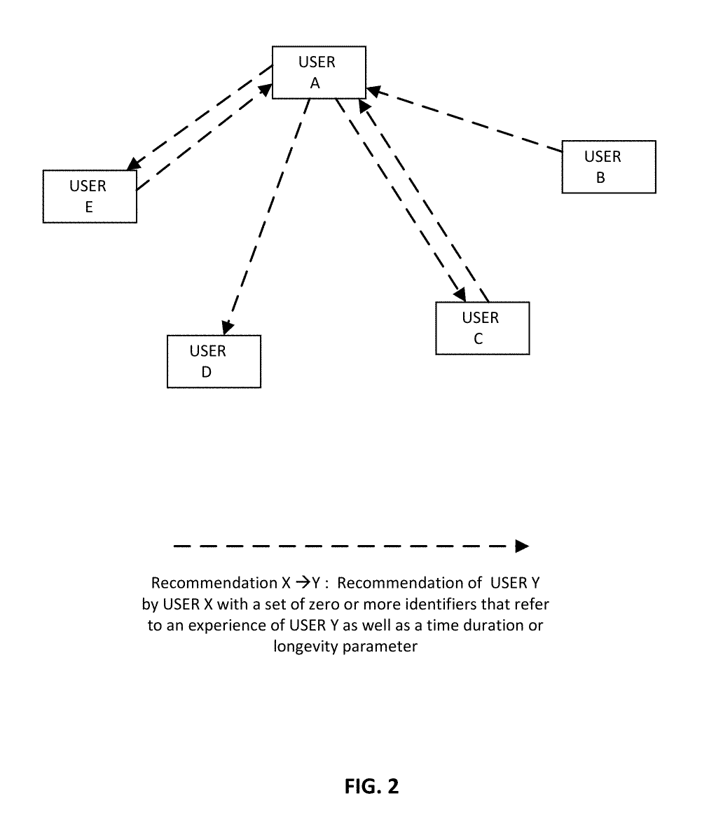

In order to illustrate the present method, consider the graph of FIG. 2 which represents recommendation involving five different users (A, B, C, D, E) depicted as nodes in the graph. An arrow with broken line represents a recommendation from one user (the recommender) to another user (the recommended). The tail end of the broken line interfaces to the recommender and head of the arrow interfaces to the recommended. Each recommendation can be associated with a set of zero or more identifiers each referring to an experience of the recommended as well as a time duration or longevity parameter. The time duration or longevity parameter characterizes the time duration of the relation between the recommender and the recommended for the particular recommendation.

In embodiments, a connection between users (for example, a connection between User B and User A) must be established before one of the users (for example, User A or User B) can submit a recommendation for the other user (for example, User B or User A). This connection can be established by one user (for example, User B) entering data to verify at least one experience of the other user (User A). The social network can process such data to determine that the verification succeeds. If so, the social network can update the profile of the two users (user A and user B) to record the connection between the two users. Once this connection is established, the user (User B) can submit a recommendation for the other user (User A) and vice versa. If the verification does not succeed, the connection between the users is not established and the user (User B) cannot submit a recommendation for the other user (User A) and vice versa.

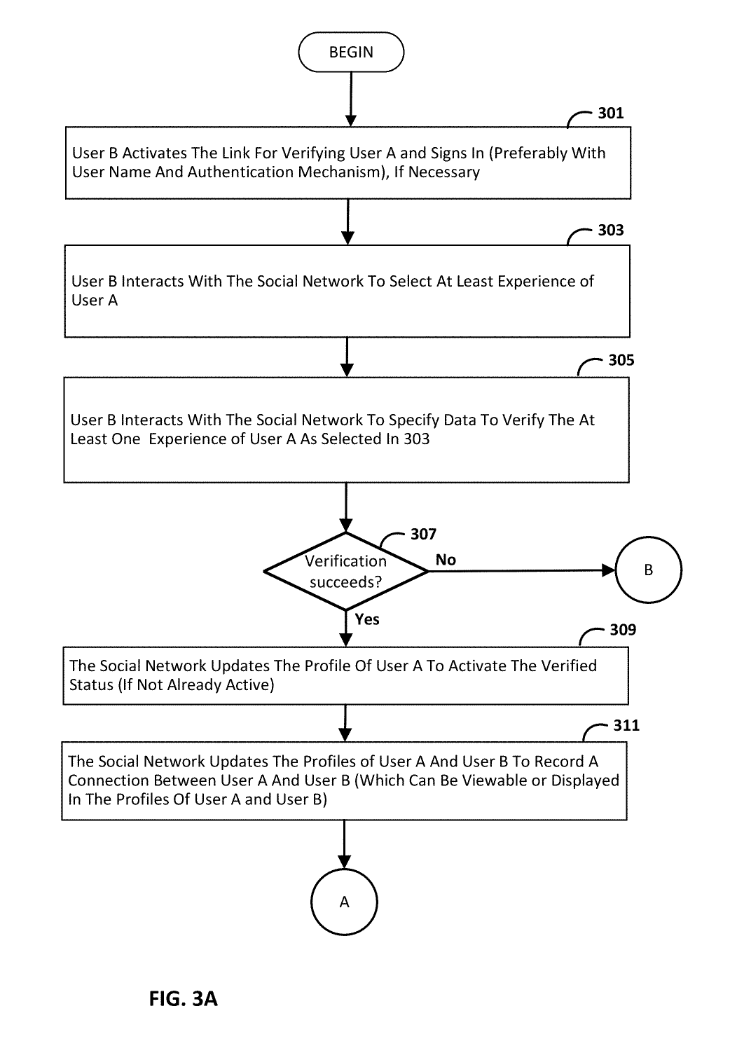

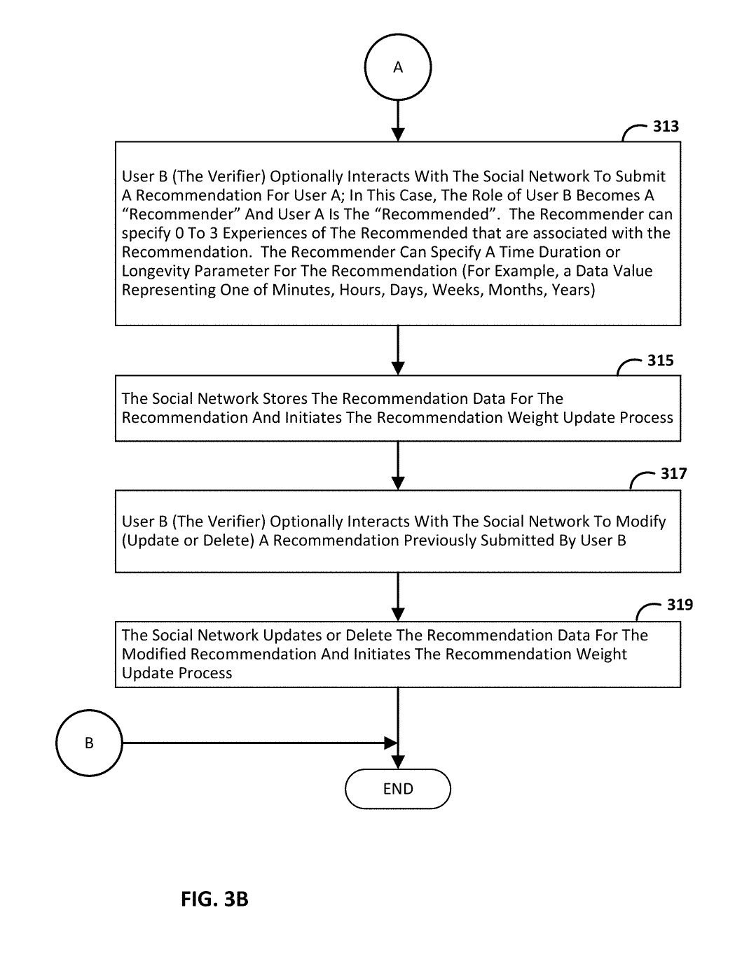

FIGS. 3A and 3B presents a view of a method for establishing a connection between users (referred to as User B and User A) of the business-oriented social network and submitting recommendations pertaining to connected users according to one example implementation. In embodiments, the method can be performed as part of step 113 of the method of FIG. 1 carried out by User B after User A has communicated a link for verifying User A to User B. The communication of such link can be part of step 109 of the method of FIG. 1 carried out by User A.

In step 301, User B activates a link for verifying User A and signs in to the social network (preferably with a username and authentication mechanism) if necessary.

In step 303, User B interacts with the social network to select at least one experience of User A. One or more experiences which are stored in the profile of User A can be presented in a list (such as a drop-down list) for selection by User B.

In step 305, User B interacts with the social network to specify data to verify the at least one experience of User A as selected in step 303. For example, the specified data can define or describe the relationship between User B and User A, the most relevant experience of User B for this relationship, the name of the job or position of User B at the time of this relationship, and possibly the entity or organization that employed User B at the time of this relationship. Some or all of the specified data can possibly be stored in the profile of User B and can be presented in one or more lists (such as drop-down lists) for selection by User B.

In step 307, the social network can process the data entered by User B in step 305 to determine whether the verification succeeds. If so, the operations proceed to steps 309 to 319 to establish the connection between the users and allow User B to submit (or modify or cancel) a recommendation for the other user (User A) and vice versa. If not, the operations of steps 309 to 319 are bypassed and the connection between the users is not established and the user (User B) cannot submit (or modify or cancel) a recommendation for the other user (User A) and vice versa.

In step 309, the social network updates the profile of User A to activate the verified status (if not already active). Note that when the verified status of a user is not active, the initial value of the total recommendation weight of that user can be set to a predefined value, such as 0. However, when the verified status of a user is active, the value of the total recommendation weight of that user can be updated to another predefined value, such as 100.

In step 311, the social network updates the profiles of User A and User B to record a connection between User A and User B (which can be viewable or displayed in the profiles of User A and User B).

In step 313, User B (the verifier) optionally interacts with the social network to submit a recommendation for User A. In this case, the role of User B becomes a “recommender” and User A is the “recommended.” The recommender (User B) can specify a set of 0 to 3 strengths (or possibly other experiences) of the recommended (User A) that are associated with recommendation. The set of strengths (or other experiences) of the recommended as specified by the recommender are preferably demonstrated by the recommended during the relationship between the recommender and the recommender and can provide a basis for the recommendation. The recommender (User B) can also specify a time duration or longevity parameter for the recommendation (for example, a data value representing one of minutes, hours, days, weeks, months, years). This time duration or longevity parameter as specified by the recommender preferably characterize the time duration of the relationship between the recommender and the recommender and can provide a further basis for the recommendation. Such time duration can be used to determine the longevity factor for the recommendation that is used as part of the recommendation weight update process as described herein.

In step 315, the social network stores the recommendation data for the recommendation submitted by the recommender (User B) in step 313 and initiates the recommendation weight update process (step 117 of FIG. 1).

In step 317, User B (the verifier) optionally interacts with the social network to modify (e.g., update or delete) a recommendation previously submitted by User B. For example, recommender (User B) can update the set of 0 to 3 experiences of the recommended that are associated with recommendation. The recommender (User B) can also update the time duration or longevity parameter for the recommendation. In another example, the recommender (User B) can delete the recommendation completely.

In step 319, the social network updates (or deletes) the recommendation data for the recommendation modified in step 317 and initiates the recommendation weight update process (step 117 of FIG. 1).

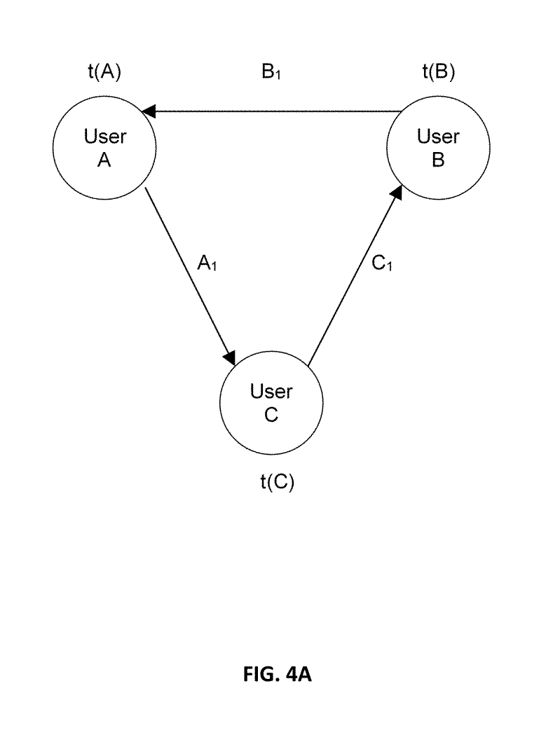

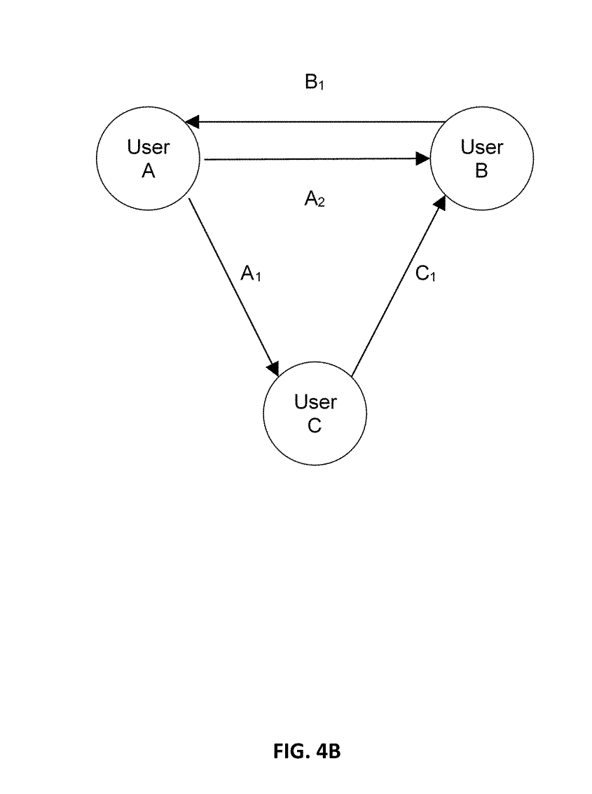

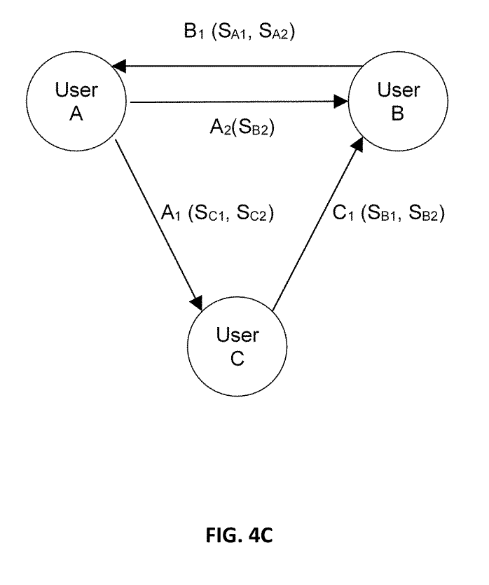

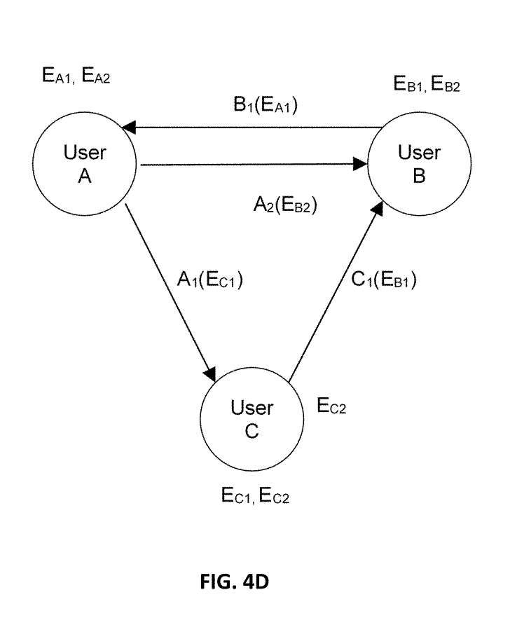

FIGS. 4A -4E are graphs that illustrate an exemplary recommendation weight update process. In embodiments, the process can be performed as part of step 117 of the method of FIG. 1. The process can be represented as a graph of nodes, where each node represents a user and the arrow connections between them are the recommendations that one user (the recommender) has provided to another user (the recommended).

FIG. 4A shows a scenario involving three users (User A, User B and User C) that have recommendations between them. User A has recommended User C (recommendation A₁). User B has recommended User A (recommendation B₁). User C has recommended User B (recommendation CO. The total recommendation weights of User A, User B and User C, are t(A), t(B) and t(C), respectively.

As described above, the total recommendation weight of a particular user is calculated from the sum of all the recommendations weights for the recommendations that the particular user has received. Thus, for any given User Y (or node) of the graph assuming that User Y is recommended by a number of other Users (denoted X1 . . . Xn), the total recommendation weight t(Y) is given as:

t(Y)=β(wᵣ(X1, Y)+ . . . wᵣ(Xn,Y)) Eqn. (1)
where 0 is a damping factor constant in the interval [0,1], which limits the extent in which the User Y's total recommendation weight will be inherited by its recommendations; and
the sum (wᵣ(X1, Y)+ . . . wᵣ(Xn, Y) represents the sum of all the recommendations weights for the recommendations that the given User Y has received.
   Furthermore, the recommendation weight wᵣ(X1, Y) given by User X1 for User Y is given by:

$${w}_{r} ( X 1 , Y ) = \frac{t ( X 1 ) {L}_{X 1 , Y} {F}_{X 1 , Y}}{{\sum }_{i = 0}^{n} {( {L}_{i} {F}_{i} )}_{X 1}} \qquad Eqn . ( 2 )$$

where t(X1) is the total recommendation weight of the User X1 (recommender);
   L_{X1,Y} is a longevity factor that depends on the time duration of the relation between User X1 (recommender) and User Y (recommended);
   F_{X1,Y} is a factor associated with the type of relation between User X1 (recommender) and User Y (recommended); for most relationship types, the factor is 1. For relationship types where the recommender is a subordinate to the recommended (for example, was led, hired, taught, mentored, or received investment by the recommended), the factor can be a higher value (such as the golden ratio of 1.6180339887); and
   the summation Σᵢ₌₀ⁿ(LᵢFᵢ)_{X1} corresponds to the total number of recommendations made by the User X1 of the given recommendation and specifically adds the multiplication product of the longevity factors and relation type factors for all the recommendations given by the User X1 (recommender).
      This same equation can be used to determine the recommendation weights wᵣ(X2, Y) . . . wᵣ(Xn, Y) for all of the other users that recommend the User Y. This means that not all the recommendations from a given user are going to be weighted equally, as the total weight of the recommender is distributed proportionally depending on the longevity and type of the relations.

In the graph of FIG. 4A, consider a value of β equal to one and the initial total recommendation weight of each user (node) given as:

t(B)=t(C)=t(A) Eqn. (3)

In embodiments, the initial state of the total recommendation weight of a user is 0 if the user hasn't been verified, and 100 if the user has been verified.

In FIG. 4B, User A has submitted a new recommendation for User B (recommendation A₂). Thus, the total recommendation weight t(B) for User B is given by Eqn. (1) as:

$$\begin{matrix}t ( B ) = β ( {w}_{r} ( A , B ) + {w}_{r} ( C , B ) ) & Eqn . ( 4 a ) \\ = 1 ( {w}_{r} ( A , B ) + {w}_{r} ( C , B ) ) & Eqn . ( 4 b ) \\ = {w}_{r} ( A , B ) + {w}_{r} ( C , B ) & Eqn . ( 4 c )\end{matrix}$$

wᵣ(A, B) is given by Eqn. (2) as:

$$\begin{matrix}{w}_{r} ( A , B ) = \frac{t ( A ) {L}_{A , B} {F}_{A , B}}{{\sum }_{i = 0}^{n} {( {L}_{i} {F}_{i} )}_{A}} & Eqn . ( 5 a ) \\ = \frac{t ( A ) {L}_{A , B} {F}_{A , B}}{{L}_{A , B} {F}_{A , B} + {L}_{A , C} {F}_{A , C}} & Eqn . ( 5 b )\end{matrix}$$

And wᵣ(C, B) is given by Eqn. (2) as:

$$\begin{matrix}{w}_{r} ( C , B ) = \frac{t ( C ) {L}_{C , B} {F}_{C , B}}{{\sum }_{i = 0}^{n} {( {L}_{i} {F}_{i} )}_{AC}} & Eqn . ( 6 a ) \\ = \frac{t ( C ) {L}_{C , B} {F}_{C , B}}{{L}_{C , B} F {,}_{CB}} & Eqn . ( 6 b ) \\ = t ( C ) & Eqn . ( 6 c )\end{matrix}$$

Combining Eqns. 4(c), 5(b) and 6(c) gives:

$$t ( B ) = \frac{t ( A ) {L}_{A , B} {F}_{A , B}}{{L}_{A , B} {F}_{A , B} + {L}_{A , C} {F}_{A , C}} + t ( C ) \qquad Eqn . ( 7 )$$

Similarly, the total recommendation weight t(A) for User A is given by Eqn. (1) as:

$$\begin{matrix}t ( A ) = β {w}_{r} ( B , A ) & Eqn . ( 8 a ) \\ = 1 {w}_{r} ( B , A ) ) & Eqn . ( 8 b ) \\ = {w}_{r} ( B , A ) & Eqn . ( 8 c )\end{matrix}$$

wᵣ(B, A) is given by Eqn. (2) as:

$$\begin{matrix}{w}_{r} ( B , A ) = \frac{t ( B ) {L}_{B , A} {F}_{B , A}}{{\sum }_{i = 0}^{n} {( {L}_{i} {F}_{i} )}_{B}} & Eqn . ( 9 a ) \\ = \frac{t ( B ) {L}_{B , A} {F}_{B , A}}{{L}_{B , A} {F}_{B , A}} & Eqn . ( 9 b ) \\ = t ( B ) & Eqn . ( 9 c )\end{matrix}$$

Combining Eqns. 8(c) and 9(c) gives:

t(A)=t(B) Eqn. (10)

Similarly, the total recommendation weight t(C) for User C is given by Eqn. (1) as:

$$\begin{matrix}t ( C ) = β {w}_{r} ( A , C ) & Eqn . ( 11 a ) \\ = 1 {w}_{r} ( A , C ) ) & Eqn . ( 11 b ) \\ = {w}_{r} ( A , C ) & Eqn . ( 11 c )\end{matrix}$$

wᵣ(A, C) is given by Eqn. (2) as:

$$\begin{matrix}{w}_{r} ( A , C ) = \frac{t ( A ) {L}_{A , C} {F}_{A , C}}{{\sum }_{i = 0}^{n} {( {L}_{i} {F}_{i} )}_{A}} & Eqn . ( 12 a ) \\ = \frac{t ( A ) {L}_{A , C} {F}_{A , C}}{{L}_{A , B} {F}_{A , B} + {L}_{A , C} {F}_{A , C}} & Eqn . ( 12 b )\end{matrix}$$

Combining Eqns. 11(c) and 12(b) gives:

$$t ( C ) = \frac{t ( A ) {L}_{A , C} {F}_{A , C}}{{L}_{A , B} {F}_{A , B} + {L}_{A , C} {F}_{A , C}} \qquad Eqn . ( 13 )$$

Eqns. (7), (10) and (13) represent a series of equations with three unknowns t(A), t(B), t(C) as follows:

$$\begin{matrix}t ( B ) = \frac{t ( A ) {L}_{A , B} {F}_{A , B}}{{L}_{A , B} {F}_{A , B} + {L}_{A , C} {F}_{A , C}} + t ( C ) & Eqn . ( 14 a ) \\ t ( A ) = t ( B ) & Eqn . ( 14 b ) \\ t ( C ) = \frac{t ( A ) {L}_{A , C} {F}_{A , C}}{{L}_{A , B} {F}_{A , B} + {L}_{A , C} {F}_{A , C}} & Eqn . ( 14 c )\end{matrix}$$

The system of equations (14a, 14b, 14c) can be solved by a number of well-known iterative algorithms that makes guesses for the three unknowns t(A), t(B), t(C) and updates the guesses over a finite number of iterations until the results provide sufficient convergence for the three unknowns. With solutions for the three unknowns t(A), t(B), t(C), the recommendation weights for the recommendations of the graph can be determined according to the Eqns. 5(b), 6(c), 9(c) and 12(b). Note that this computational model can readily be extended to represent any number of arbitrary users and recommendations between such users.

FIG. 4C is a graph that illustrates strengths (or other experiences) of the recommended that are associated with recommendations. In this case, S_{C1} and S_{C2} are two different strengths (or other experiences) of User C that are associated with the recommendation A₁ given by User A to User C. S_{B1} and S_{B2} are two different strengths (or other experiences) of User B that are associated with the recommendation C₁ given by User C to User B. S_{A1} and S_{A2} are two different strengths (or other experiences) of User A that are associated with the recommendation B₁ given by User B to User A. S_{B2} is a strength (or other experiences) of User B that is associated with the recommendation A₂ given by User A to User B. The strength(s) (or other experiences) associated with a given recommendation can be assigned corresponding per-strength (or per-experience) recommendation weight(s) by distributing the recommendation weight of the given recommendation evenly across the strength(s) (or experiences) associated with the given recommendation.

Thus, assuming the recommendation weight for the recommendation C₁ is given as wᵣ(C₁), the per-strength recommendation weights wᵣ(S_{B1}, C₁) and wᵣ(S_{B2}, C₁) for the strengths S_{B1} and S_{B2} of User B that are associated with the recommendation C₁ can be equated as:

wᵣ(S_{B1}, C₁)=wᵣ(S_{B2}, C₁)=wᵣ(C₁)/2. Eqn. (15)

Similarly, assuming the recommendation weight for the recommendation A₂ is given as wᵣ(A₂), the per-strength recommendation weight wᵣ(S_{B2}, A₂) for the strength S_{B2} of User B that is associated with the recommendation A₂ can be equated as:

wᵣ(S_{B2}, A₂)=wᵣ(A₂). Eqn. (16)

Furthermore, the per-strength (or per-experience) recommendation weight(s) for a given strength (or experience) of a user can be summed over the recommendations received by the user to calculate a total per-strength (or per-experience) recommendation weight for the given strength (or experience) of the user. For example, the per-strength recommendation weights wᵣ(S_{B2}, A₂) and wᵣ(S_{B2}, C₁) for the strength S_{B2} of User B for the recommendations A₂ and C₁ received by User B can be summed to provide a total per-strength recommendation weight for the strength S_{B2} of User B equal to [wᵣ(S_{B2}, A₂)+wᵣ(S_{B2}, C₁)]=[wᵣ(A₂)+wᵣ(C₁)/2].

It is also contemplated that users can specify and store “experience recommendations”, which is an action where one person (the “recommender”) recommends or endorses a particular experience of another person (the “recommended”). FIG. 4D shows a scenario involving three users (User A, User B and User C) that have experience recommendations between them. User A has recommended an experience Eci of User C (experience recommendation A₁) and has recommended an experience E_{B2} of User B (experience recommendation A₂). User B has recommended an experience E_{A1} of User A (experience recommendation B₁). User C has recommended an experience E_{B1} of User B (experience recommendation C₁).

In this embodiment, the weight update process can calculate a total experience recommendation weight for each user (e.g., A, B, C) in a manner similar to the total recommendation weights derived from the user-to-user recommendations as described herein. In this case, the total experience recommendation weight for each user can be calculated from the sum of all the experience recommendation weights for the experience recommendation that the particular user has received and possibly a damping factor similar to Eqn. (1) as described above.

Furthermore, the weight update process can calculate weights (or scores) associated with each experience recommendation (e.g., A₁, A₂, B₁, C₁) in a manner similar to the recommendation weights associated with the user-to-user recommendations as described herein. In this case, the experience recommendation weight for a given experience recommendation can be derived from the total experience recommendation weight of the recommender given experience recommendation, a longevity factor that depends on the time duration of the relation between the recommender and recommended of the given experience recommendation, a factor associated with the type of relation between the recommender and the recommended of the given experience recommendation, and a summation that corresponds to the total number of experience recommendations made by the recommender of the given experience recommendation (preferably adding the multiplication product of the longevity factors and relation type factors for all the experience recommendations given by the recommender of the experience recommendation) similar to Eqn. (2) as described above.

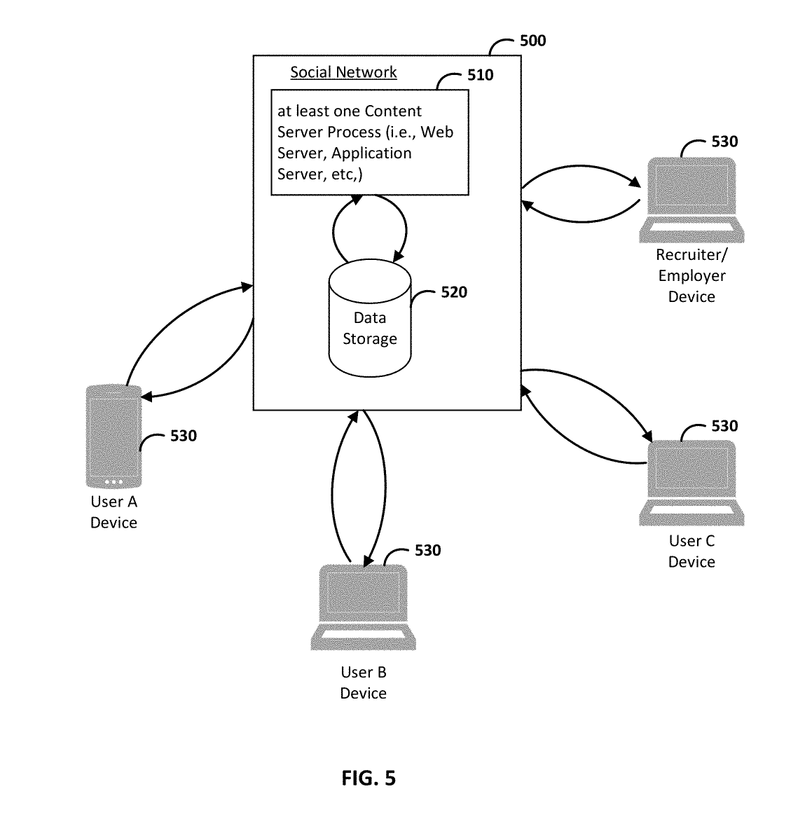

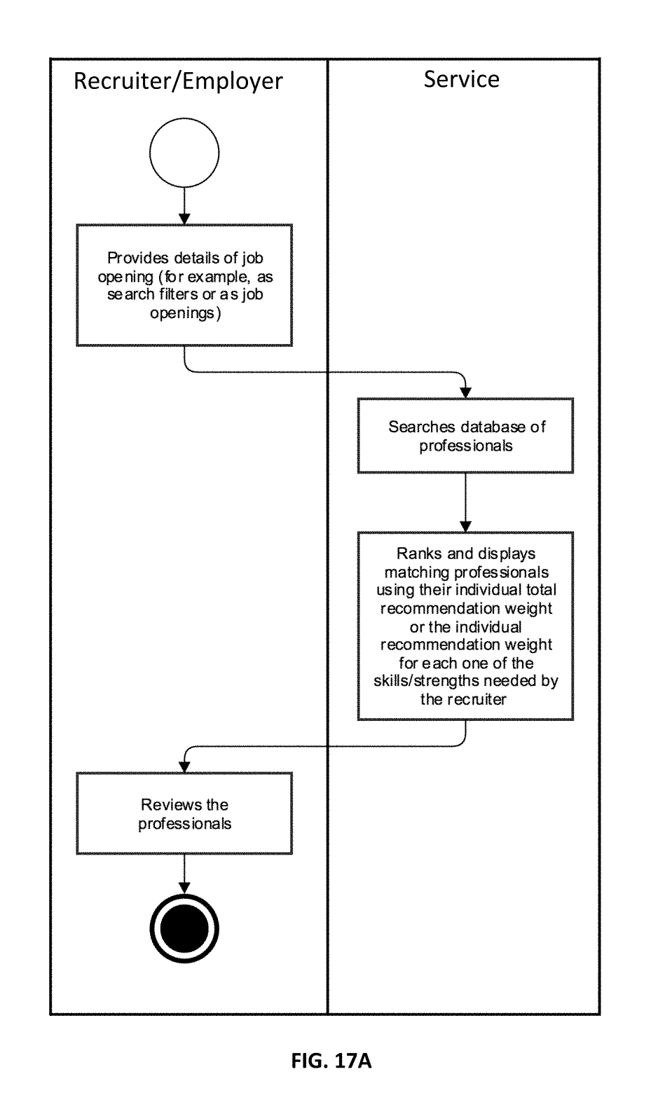

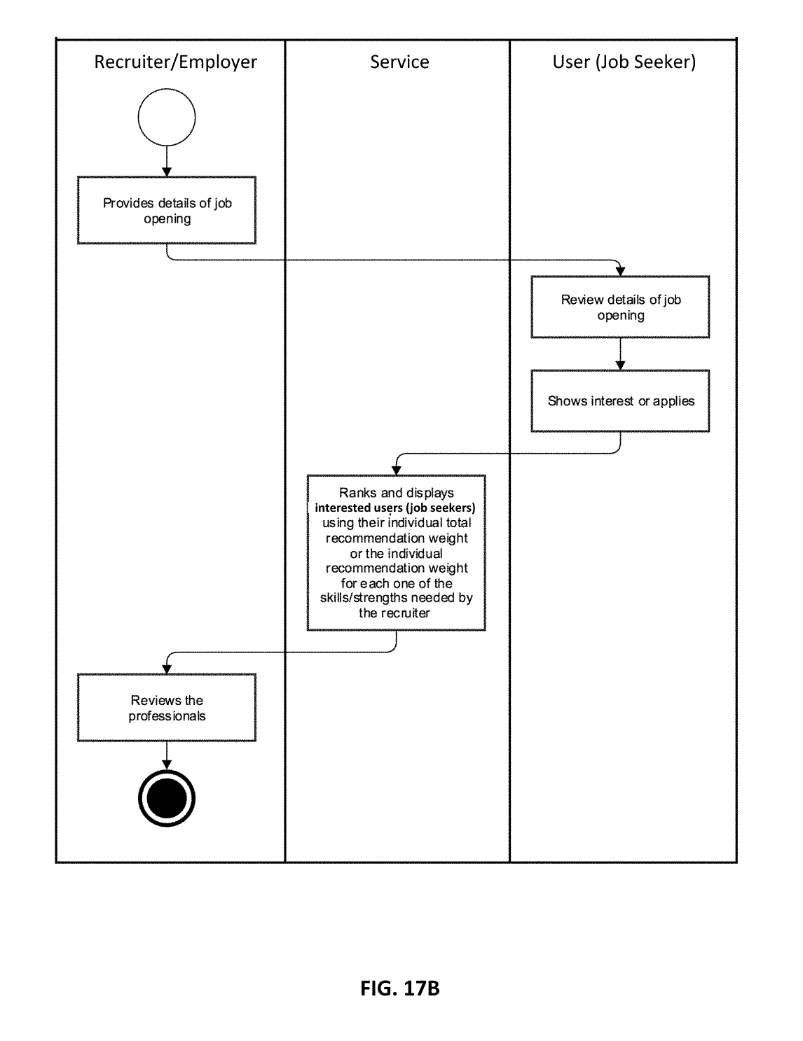

FIG. 5 shows an example business-oriented social network 500 according to one example of the current disclosure. Social network 500 may contain a content server process 510. Content server process 510 may communicate with data storage 520 and users through a communication network. Content server process 510 may be responsible for the retrieval, presentation, and maintenance of registered user profiles stored in data storage 520 and interaction with the users according to the operations of FIG. 1 and FIGS. 17A and 17B as described herein in detail. Content server process 510 in one example may include or be a web server that fetches or creates internet web pages, which may include portions of, or all of, a registered user profile at the request of users.

Users may be an individual, group, user or member, prospective user, recruiters or employers, or other users of the social network 500. Users access the social network 500 using a computer system 530 through a communication network. The communication network may be any means of enabling the social network 500 to communicate data with a computer remotely, such as the interne, an extranet, a LAN, WAN, wireless, wired, or the like, or any combination. The user computer systems 530 can be any one of a number of different types of computer systems, including PCs, workstations, notebooks, tablets, smartphones, other mobile devices, and other data communication enabled computing devices.

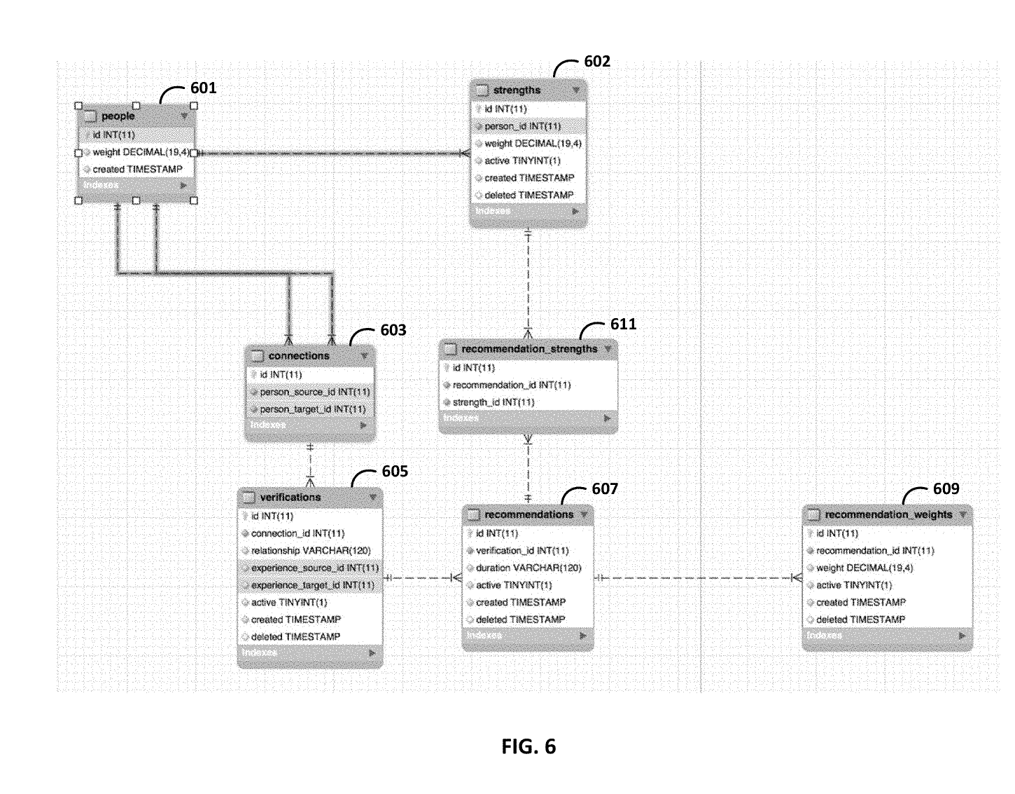

FIG. 6 shows a schema for exemplary data structures maintained by the business-oriented social network. The data structures include a people table or object 601 for each registered user, which includes an “id” field for identifying the registered user, a “timestamp” field representing the data and time that the registered user was created, and a “weight” field that represents the total recommendation weight for the registered user.

The data structures also include a strengths table or object 602 for each strength or other experience of the users, which includes an “id” field for identifying the strength or other experience, a “person_id” field that refers or links to the people table or object 601 to specify the user to which the strength or other experience belongs, a “weight” field that represents the current value of the per-experience weight for the strength or other experience, an “active” field that represents whether or not the strength or other experience is active, and “timestamp” fields representing the data and time that the verification was created and deleted (if applicable).

The data structures also include a connections table or object 603 for each connection between users, which includes an “id” field for identifying the connection, a “person source_id” field that refers or links to the people table or object 601 for one user (source user) of the connection, and a “person_target_id” field that refers or links to the people table or object 601 for the other user (target user) of the connection. The connection is a reciprocal relationship between two users and it must be accepted by both parties. In embodiments, a connection can be deleted by any one user (party) of the connection.

The data structures also include a verification table or object 605 that represents the verification of one user (target user) by another user (source user), which includes an “id” field for identifying the verification, a “connection_id” field that refers or links to a corresponding connection table or object 603 to specify the target user and source user of the verification, a “relationship” field that represents the type of relation of the source user to the target user, an “experience_source_id” field that refers to or links to an experience of the source user that pertains to the verification, an “experience_target_id” field that refers to or links to an experience of the target user that pertains to the verification, an “active” field that represents whether or not the verification status of the target user is active, and “timestamp” fields representing the data and time that the verification was created and deleted (if applicable). The verification is a public acknowledgement that one user gives to another user as a result of a shared professional experience. The verification need not be reciprocal. The verification can be rejected by the recipient user. A verification is different from a recommendation, but it can have one or more recommendations associated with it. The verification can serve to add trustworthiness to the recipient user and associated user profile data.

The data structures also include a recommendations table or object 607 that represents a recommendation given by one user (source user or recommender) to another user (target user or recommended), which includes an “id” field for identifying the recommendation, a “verification_id” field that refers or links to a corresponding verification table or object 605 and linked connection table or object 603 to specify the target user and source user of the recommendation, a “duration” field that represents the longevity of the relation between the target user and source user upon which the recommendation is based, an “active” field that represents whether or not the recommendation is active, and “timestamp” fields representing the data and time that the recommendation was created and deleted (if applicable).

The data structures also include a recommendations weights table or object 609 that represents the recommendation weight associated with a recommendation, which includes an “id” field for identifying the recommendation weight, a “recommendation_id” field that refers or links to a recommendations table or object 607 for specifying the recommendation that is associated with the recommendation weight, a “weight” field that represents a current value of the recommendation weight, an “active” field that represents whether or not the recommendation weight is active, and “timestamp” fields representing the data and time that the recommendation weight was created and deleted (if applicable).

The data structures also include a recommendations strengths table or object 611 that associates a recommendation and strength of a user, which includes an “id” field for identifying the associated table or object, a “recommendation_id” field that refers or links to a recommendations table or object 607 and “a strength_id” field that refers or links to a strength table or object 602 for specifying the associated recommendation and strength of a user.

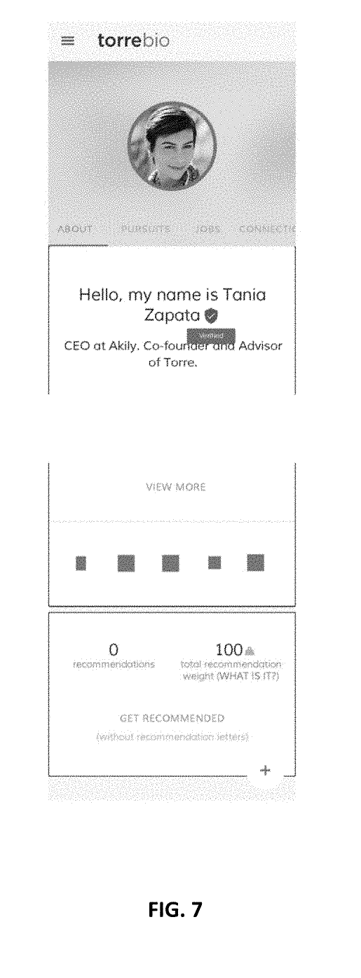

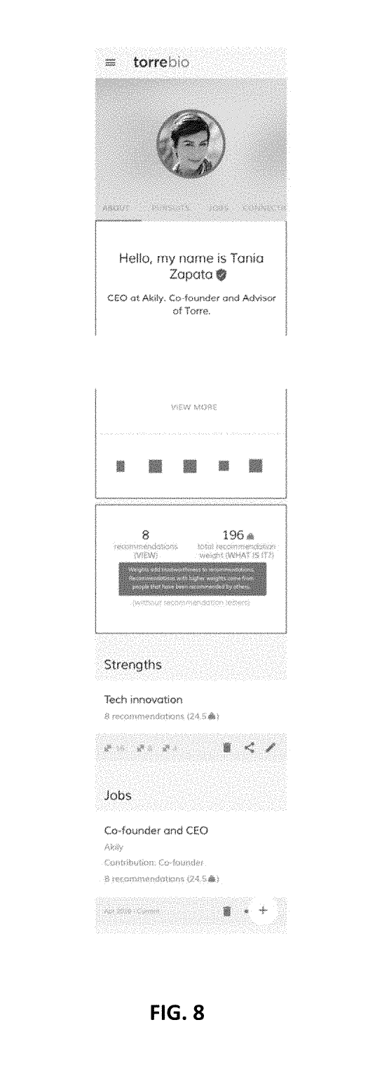

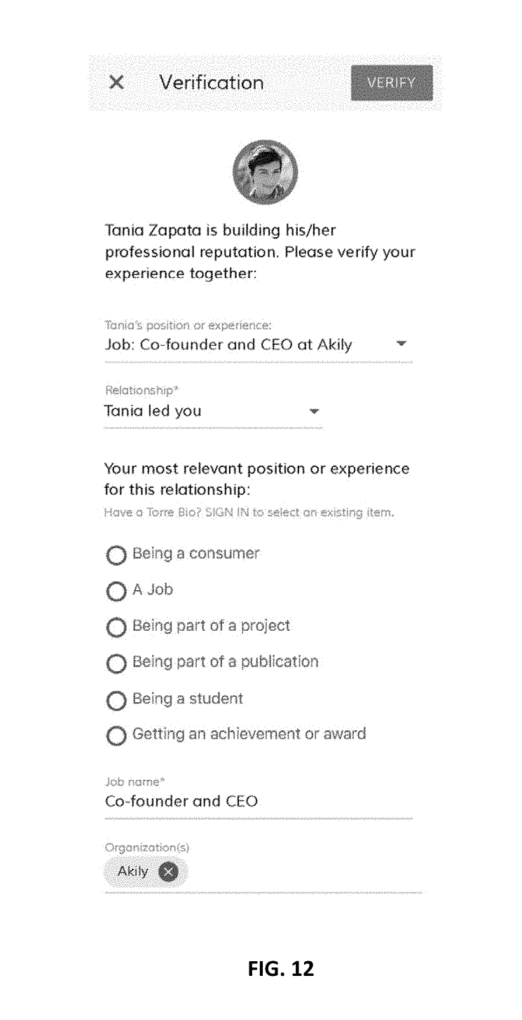

FIGS. 7-16 show screen captures (e.g., display screens) of example user interfaces that are presented by the social network for display on user computer systems and implement operations of the present disclosure. FIG. 7 shows a user interface that can be presented to a user upon login. The top part presents the user's name, profile picture, and current job title(s) and company name(s). The bottom part presents the number of recommendation received by the user and the total recommendation weight of the user. The user can click on the “VIEW MORE” field to present additional profile information as shown in FIG. 8, which include information relating to strengths or other experience of the user with associated per-experience recommendation weights. In this example, the user has received 8 recommendations associated with both a “Tech Innovation” experience and a “Co-founder and CEO” job experience. Furthermore, the system has calculated a per-experience recommendation weight of 24.5 for both the “Tech Innovation” experience and the “Co-founder and CEO” job experience, which is displayed directly under the respective listings of the “Tech Innovation” experience and “Co-founder and CEO” job experience as shown. Note that the interface also provides widgets to delete and edit these experiences and share these experiences as shown. The interface can also display the recommendation weights for the recommendations received by the user as part of the display of the user's profile. It can also display the recommendations that the user has made and associated recommendation weights as part of the display of the user's profile.

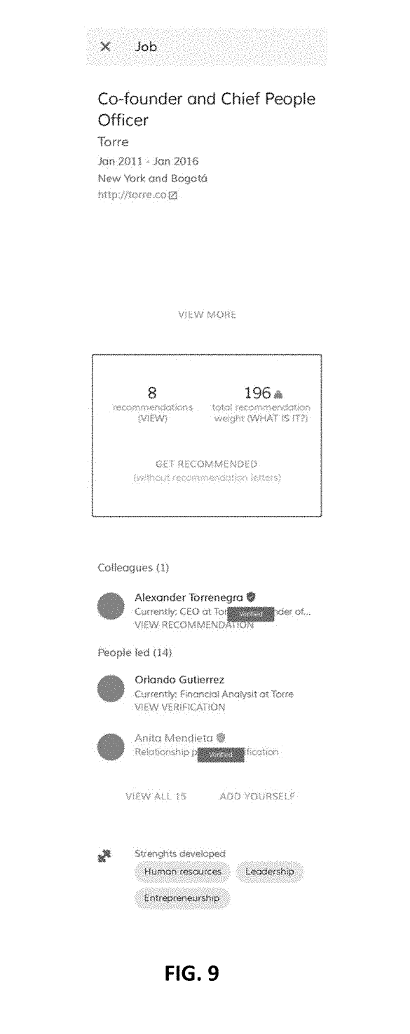

FIG. 9 shows the user interface that can be presented to a user in viewing a particular job. It can present the title, company, time frame, and location for the job as shown, along with the ability to edit such information. It can also present the number of recommendation received by the user and the total recommendation weight of the user. It can also present colleagues of the user and people led by the user of the user, the verification status of such users, and widgets to view verifications or recommendations pertaining to these users. It can also present a list of strengths or other experiences of the user that is associated with the job as shown.

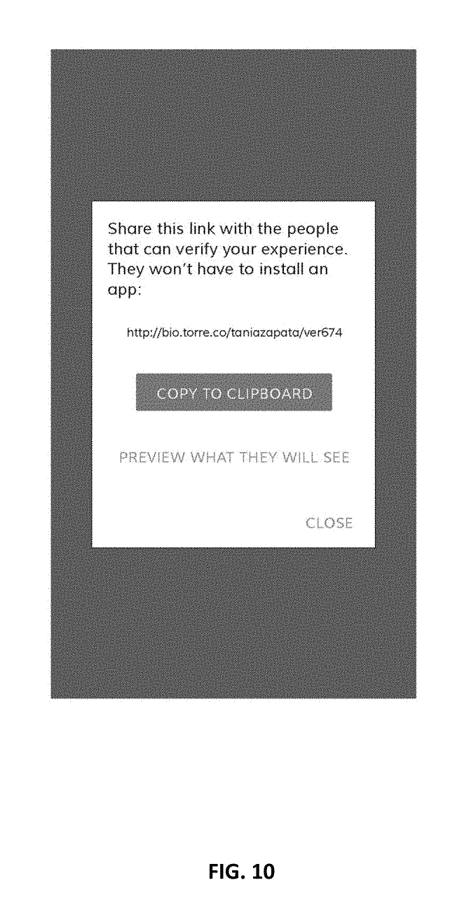

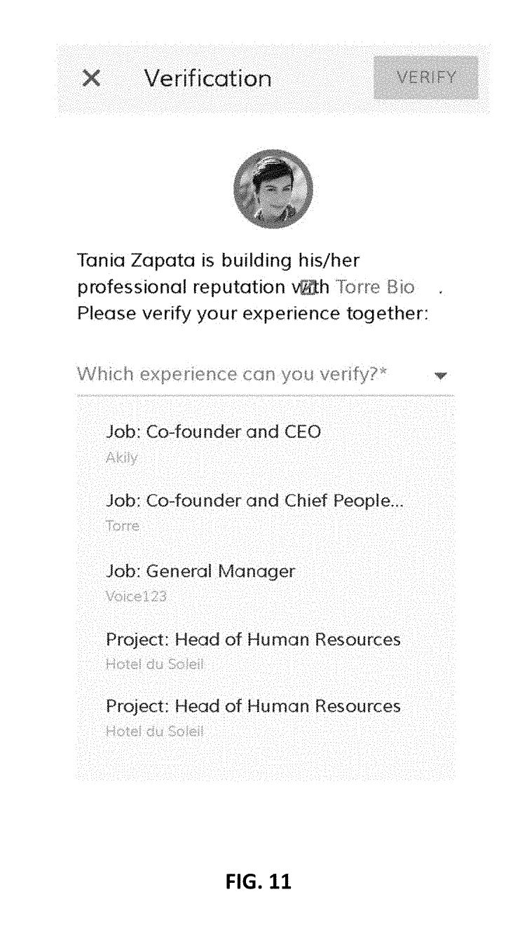

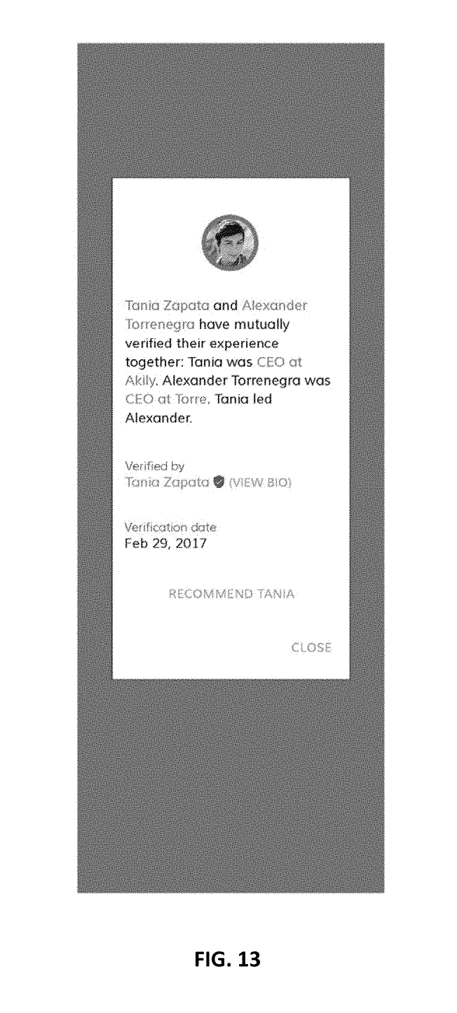

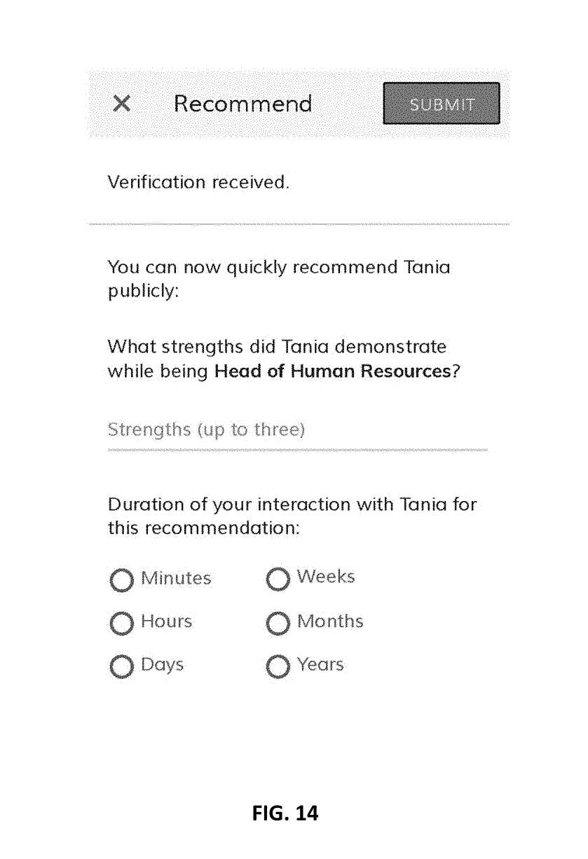

FIG. 10 shows an interface that presents a link that is operative to verify one or more experiences of a particular user (target user). The link can be communicated or shared by the target user to another user or potential user (verifier or source user) of the social network for such verification. When the link is activated by the source user, the social network can present an interface that allows the source user to verify one or more experiences of the target user (in this case “Tania Zapata”) as shown in FIGS. 11, 12 and 13. The interface includes a drop-down list that allows source user to select an experience of the target user to verify as shown in FIG. 11. The target user then specifies the type of relation between source user and the particular user (for example by a drop-down list) as well as specifics of the job and experience that is most relevant to the relationship between the source user and the target user. After specifying this information, the source user submits the information by clicking on the “VERIFY” button in the upper right corner of the interface. In response to this request, the social network processes the information entered by the source user to determine whether the verification succeeds (Step 307 of FIG. 3A). If the verification succeeds, the source user can be presented with a notification interface as shown in FIG. 13, which includes a button (in this case labeled “RECOMMEND TANIA” button) that when activated allows the source user to recommend the target user as shown in FIG. 14

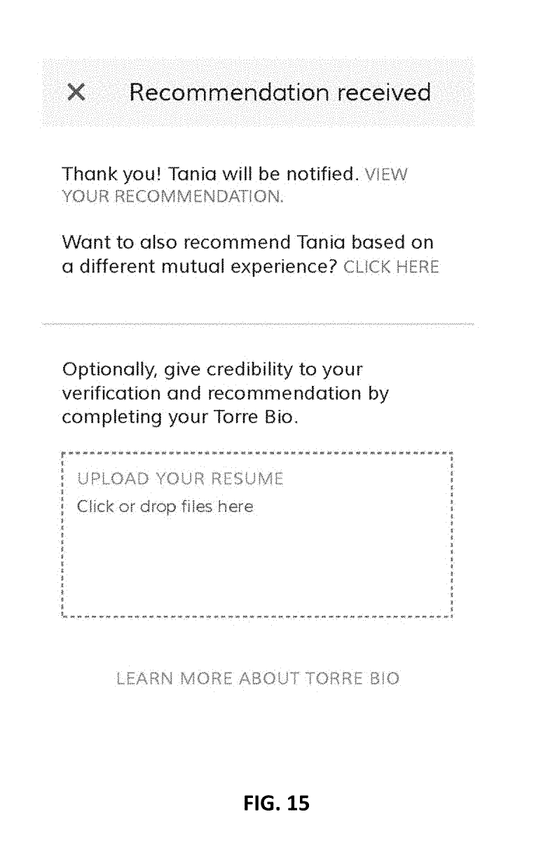

FIG. 14 shows an interface that allows the source user to recommend the target user. The interface includes a field where the source user can specify zero to three strengths or other experiences of the target user that are associated with the recommendation. The interface allows includes check buttons where the source user can specify a time duration for the relationship/interaction between the source user and target user upon which the recommendation is based. Such time duration can be used to determine the longevity factor for this particular recommendation that is used as part of the recommendation weight update process as described herein. After specifying this information, the source user submits or commits the recommendation by clicking on the “SUBMIT” button in the upper right corner of the interface. In response to this request, the social network stores the recommendation data and initiates the recommendation weight update process (Step 315 of FIG. 3B) and provides the source user with the interface of FIG. 15. Similar interfaces can be used to edit or delete a recommendation.

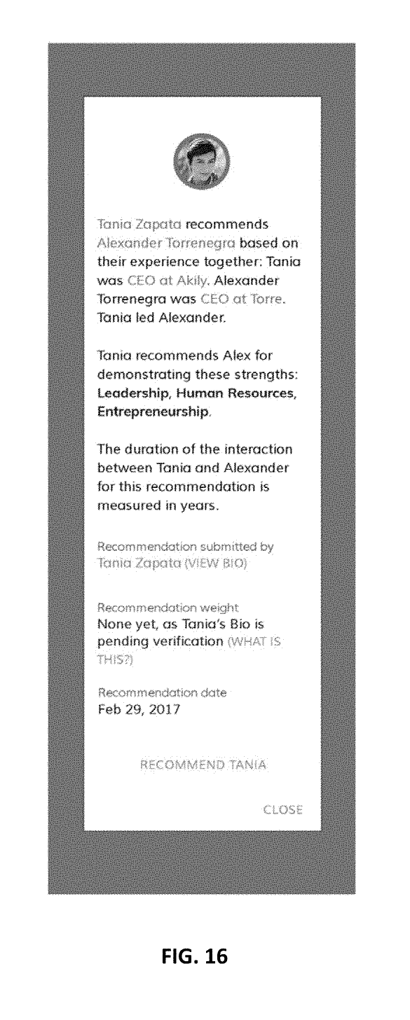

FIG. 16 shows an interface that presents the details of the recommendation to users of the social network. Note that this interface includes information that describes the source user and target user of the recommendation, the set of strengths or other experiences of the target user that are associated with the recommendation, the duration of the relationship between the source user and the target user that is the basis for the recommendation, and the recommendation weight for the recommendation as determined by the recommendation weight update process as described herein.

In embodiments, the operations of the social network can be extended to allow recruiters or employers to search the database of user profiles maintained by the social network to identify and review potential candidates for a job opening as shown in FIG. 17A. In this embodiment, the recruiter/employer can access the social network and provide details of a job opening. In response thereto, the social network searches the database of user profiles maintained by the social network to find users that match the details of the job opening. These matches users can be ranked and displayed by the social network based on the total recommendation weights of the matched users (with higher weighted users presented first above lower weighted users). Additionally or alternatively, the recruiter/employer can specify one or more per-experience recommendation weights, and the social network can rank and display the matched users based on the specified one or more per-experience recommendation weights of the matched users. In both cases, the recruiter or employer can interact with the display of ranked matched users to review the profiles of the users as desired.

In other embodiments, the operations of the social network can be extended to allow recruiters or employers to provide details of job opening to users of the social network as shown in FIG. 17B. The users can review the details of the job opening and submit an interest or apply to a particular job, which associates the user (referred to as an “interested user”) to a particular job opening. For a given job opening, the social network can rank and display the interested users associated with the given job opening based on the total recommendation weights of the interested users (with higher weighted users presented first above lower weighted users). Additionally or alternatively, the recruiter/employer can specify one or more per-experience recommendation weights, and the social network can rank and display the interested users associated with the given job opening based on the specified one or more per-experience recommendation weights of the interested users. In both cases, the recruiter or employer that seeks to fill the given job opening can interact with the display of ranked interested users to review the profiles of the users as desired.

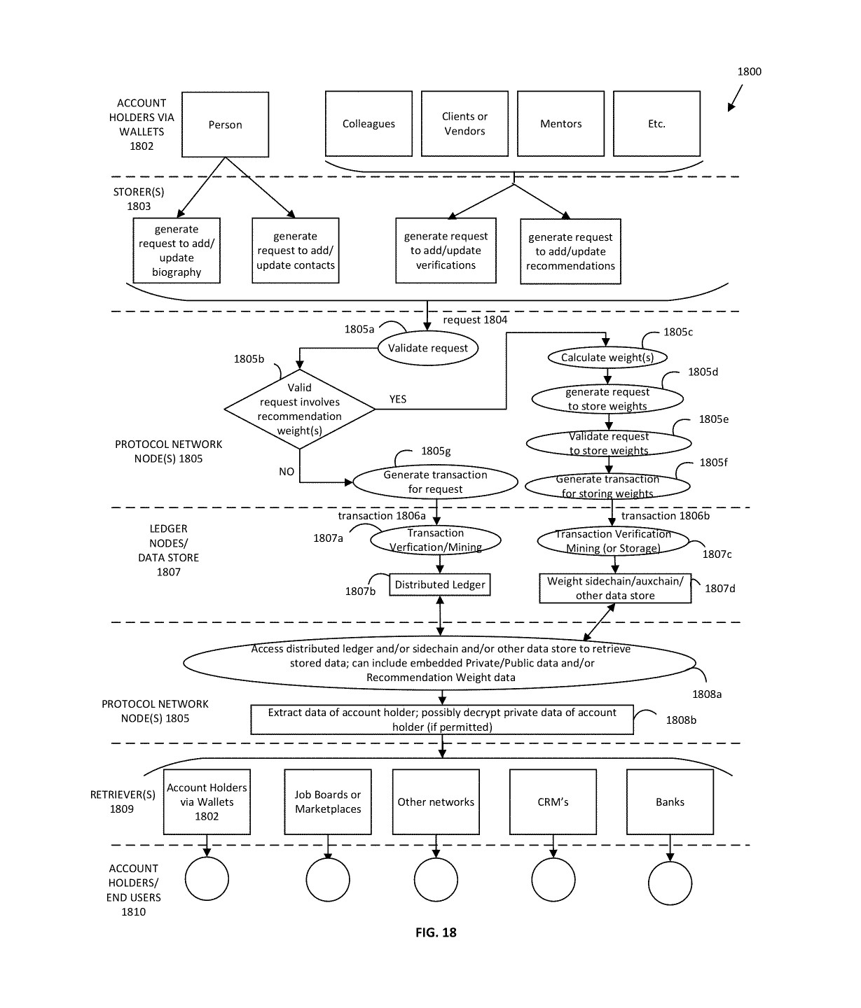

In an alternate embodiment, the business-oriented social network as described herein can be embodied by a decentralized network as shown in FIG. 18, which includes a number of participants that include account holders (or users of the social network), one or more storers, one or more protocol network nodes, one or more retrievers, and end-users (who need not be an account holder or user). The participants can be referred to as “nodes” of the social network and each node can be embodied by processor-based system or other suitable processing device or system as described herein. The participants will be described in further detail below.

First, it will be noted that account holders (or users) can include various types of parties, including individuals, colleagues, clients or vendors, mentors, etc. It is contemplated that an account holder will use electronic wallet functionality (or wallet) 1802 as shown that cooperates with one or more storer nodes 1803 to generate requests 1804 to add or update user profile data of the account holder. For example, such requests 1804 can add or update the biographical data of the account holder, add or update contacts data of the account holder (which refers to other account holders that are connected or linked to the account holder), add or update verification data of the account holder, and/or add or update recommendation data of the account holder. The requests 1804 generated by the storer node(s) 1803 are supplied to one or more network protocol nodes 1805, which process such requests in accordance with steps 1805a-1805g described in detail below. In essence, the wallet functionality 1802 and storer node(s) 1803 provide an interface between the account holders and the protocol network nodes 1805 in order to generate and issue requests to add, or modify profile data of the account holder as stored on the distributed ledger 1807b or possibly stored in a side chain or aux chain or other data store 1807c as described in detail below. The wallet functionality 1802 can be realized by online electronic wallet systems, hot or cold wallets, hardware-based wallets, etc. The wallet functionality and the storer node(s) can interact in many ways, including widely adopted protocols such as OAuth. Note that the wallet functionality 1802 can store public and private encryption keys or other passwords. The private encryption key of the account holder can be used by the wallet functionality to digitally sign requests issued by the account holder and supplied to the one or more network protocol nodes 1805. In alternate embodiments, the account holders can employ software functionality that interfaces directly with the one or more network protocol nodes 1805 to supply requests that are digitally signed by the account holder using a private encryption key or other password of the account holder.

Note that each and every account holder can be associated with a network account (or wallet account) and a unique account ID, which uniquely identifies the account and correspond account holder on the social network. The profile data of a given account holder can also include one or more data structure types as described in the present application (e.g., see FIG. 6). Examples of such data structure types include biographical information about the account holder, organizational information associated with the account holders past and present employers, experience(s) associated with the account holder, verifications associated with the account holder, recommendations associated with the account holder, connections associated with the account holder, interests associated with the account holder, account strengths and skills associated with the account holder, strengths and skills associated with the account holder, and account information associated with the account holder. Further details of a schema of the data structure types are provided hereinbelow. As a whole, in one embodiment, the profile data contained in the data structures can be used to construct an enhanced, structured curricula vitae of an account holder. In one embodiment, some or all of the profile data structures are stored on a distributed ledger 1807b (such as the blockchain). It is also possible that some of the profile data structures (such as recommendation weights for the account holders) can be stored in a side chain or auxiliary chain or other data store 1807d. Note that once a transaction is committed to the blockchain, the transaction is immutable and cannot be deleted. However, some transaction types (such as a recommendation transaction) may be modified or reversed or retracted by a subsequent transaction, but it cannot be deleted.

Note that the account holders can control access to any private data stored on the distributed ledger 1807b or other data store 1807d through the use of public/private key encryption technologies as described below.

As used herein, a blockchain is a continuously growing list of records, called blocks, which are linked and secured using cryptography. Each block typically contains a cryptographic hash of the previous block, a timestamp and transaction data. A blockchain is an open, distributed ledger that can record transactions efficiently and in a verifiable and permanent way. For use as a distributed ledger, a blockchain is typically managed by a peer-to-peer network collectively adhering to a protocol for inter-node communication and validating new blocks, which is hereinafter termed “mining” blocks of the blockchain. By design, a blockchain is inherently resistant to modification of the data. Once recorded, the data in any given block cannot be altered retroactively without the alteration of all subsequent blocks, which requires collusion of the network majority. Blockchains are secure by design and exemplify a distributed computing system with high Byzantine fault tolerance. Decentralized consensus has therefore been achieved with a blockchain. This makes blockchains potentially suitable for the recording of events and records, such as transaction processing.

In the decentralized network of FIG. 18, the protocol network node(s) 1805 can operate to receive, validate and process requests to add or update the structured profile data of the account holder. Such a request should include a digital signature signed with the private encryption key of the account holder, and validation of the request can verify the digital signature against the public key of the account holder as stored in the distributed ledger. The protocol network node(s) 1805 can also perform calculations required by the network protocol as a precondition of the task of adding and/or updating the structured data. For example, in response to a request to add or update a recommendation for an account holder (user), in block 1805c the protocol network node(s) 1805 can automatically calculate the total recommendation weight of the account holders (or users) as well as the recommendation weights of the recommendations given by the account holders (or users). Details of exemplary calculations of such recommendation weights are described above with respect to FIGS. 4A-4D. A recommendation given by an account holder (user) need not be reciprocal, and the account holder (user) that receives the recommendation can reject it. Furthermore, the recommendation weight that is assigned to the recommendations given by an account holder (user) is scarce. That is, with each given recommendation, the overall weight of the account holder's recommendation (their reputation weight) can diminish proportionally. Thus, the recommendations made by an account holder (user) who recommends selectively (with less frequency) have greater recommendation weight than those made by an account holder (user) who is recommend less selectively (with higher frequency). It is contemplated that an account holder (or user) can reverse or retract an earlier recommendation by a subsequent request. In this case, the calculation of the recommendation weights can be adjusted accordingly. In one embodiment, the total recommendation weight of the account holder (or user) who retracted the earlier recommendation can be calculated based upon all recommendations given by the account holder (or user), including any and all retracted recommendations. The protocol network node(s) 1805 can also responsible for generating transactions (labeled 1806a) based on valid requests issued by the storer node(s) on behalf of the account holders or issued directly by an account holder (block 1805g). Each transaction 1806a (when validated and stored on distributed ledger) adds or updates profile data of a respective account holder as referenced in the transaction 1806a. Some or all of the transactions generated by the protocol network node(s) 1805 can be communicated to a network of ledger nodes for verification and storage in the distributed ledger 1807b. The protocol network node(s) 1805 can also responsible for generating transactions based on requests generated automatically by operation of the protocol network node(s) 1805. For example, the protocol network node(s) 1805 can generate transactions 1806b to store the calculated recommendation weights of the account holders (block 1805f). Each transaction 1806b (when validated and stored) adds or updates recommendation weight profile data of a respective account holder as referenced in the transaction 1806b. Certain transactions (such as recommendation weight transactions 1806b) that carry data to be stored in a side chain or aux chain or other data store can be communicated to the other data store for verification and storage.

The protocol network node(s) 1805 can be configured to carry out a predefined set of actions that add or update profile data of an account holder in response to the requests supplied thereto. The predefine set of actions cooperate with the ledger nodes or other data store 1807 to add or update the profile data of an account holder as stored in the distributed ledger 1807b or in the side chain or aux chain or other data store 1807d. Illustrative examples of actions that can be included in this set include, but are not limited to, the following:

create an account for an account holder;

update an account of an account holder;

update biographic information of an account holder

create an organization for an account holder;

create an experience of an account holder;

update an experience of an account holder;

delete an experience of an account holder;

creates a strength/skill of an account holder;

update a strength/skill of an account holder;

delete a strength/skill of an account holder;

creates an interest of an account holder;

update an interest of an account holder;

delete an experience of an account holder;

create a recommendation between a recommender account holder and a recommended account holder;

updates longevity of affiliation between recommender account holder and the recommended account holder;

add new strength/skill to a recommendation;

retract a recommendation;

reject a recommendation (by the recommended account holder);

create a verification; and

reject a verification (by the recipient account holder);

retrieve all or part of the transaction data stored in the distributed ledger 1807b for an account holder; and

retrieve all or part of the transaction data stored in the side chain or other data store 1807d for an account holder.

The network of ledger nodes can be configured to verify the transactions supplied thereto and add valid transactions to new blocks that are created or mined (such operations are labeled block 1807a). The new blocks are stored as part of the distributed ledger 1807b. Certain transactions (such as transactions 1806b that involve recommendation weights) that carry data to be stored in a side chain or aux chain or other data store can also be verified and added to the side chain or aux chain or other data store 1807d by mining or other suitable data storage operations (such operations are labeled block 1807c).

As noted above, the participants of the network can also include one or more retriever(s) and end users. The retriever(s) 1809 are configured to cooperate with the protocol network nodes 1805 to access the transaction data of a respective account holder as stored in the distributed ledger 1807b or in the sidechain or aux chain or other data store 1807d (block 1808a), extract the public data and/or encrypted private data of the respective account holder from such transaction data and possibly decrypt the private data of the respective account holder (block 1808b), and publish the profile data respective account holder or part thereof. If and when an account holder has requested access to encrypted private data (or the account holder has authorized another participant to access such encrypted private data), the retriever(s) 1809 can cooperate with the wallet functionality 1802 of the respective account holder to decrypt the encrypted private data (using the private encryption key of the account holder). The decrypted private data of the account holder can be communicated (for example, over an encrypted link) from the wallet to the retriever 1809 that requested the private data.

The retriever(s) 1809 can be software-implemented applications that execute on one or more computing platforms and that benefit from accessing and, in some cases, processing and publishing the profile data of account holders as stored in the distributed ledger 1807b or in the sidechain or aux chain or other data store 1807d. The retriever(s) 1809 can be part of the functionality implemented by job boards, marketplaces, other networks, customer relationship managers (CRM), banks, etc. For example, the retriever(s) 1809 can be part of the job recruitment functionality that implement the workflow of FIGS. 17A and 17B as described herein.

Note that the end users 1810 may not have any profile data stored on the distributed ledger 1807b or in the sidechain or aux chain or other data store 1807d, but may access and read such data using the retriever(s) 1809. Note that some or all end users 1810 may have accounts or subscriptions established with the retrievers(s) to use the data that the retrievers provide as read from the distributed ledger 1807b or from the sidechain or aux chain or other data store 1807d. In embodiments, the wallet functionality 1802 can act as and have the same or similar functionality as the end-users 1810. Thus, it may be that account holders, acting as end users, may use the wallet functionality 1802 to cooperate with the retriever(s) functionality 1809 to read profile data from the distributed ledger 1807b or from the sidechain or aux chain or other data store 1807d. For example, software applications (such as mobile application, desktop application or web-based applications) can be controlled by account holders (or end users) and operate as retrievers 1809 to the read the profile data of a respective account holder as stored in the distributed ledger 1807b or in the sidechain or aux chain or other data store 1807d and publish or display such profile data. Such applications can possibly include graphical user interfaces similar to the graphical user interfaces of FIGS. 7-16 as described herein.

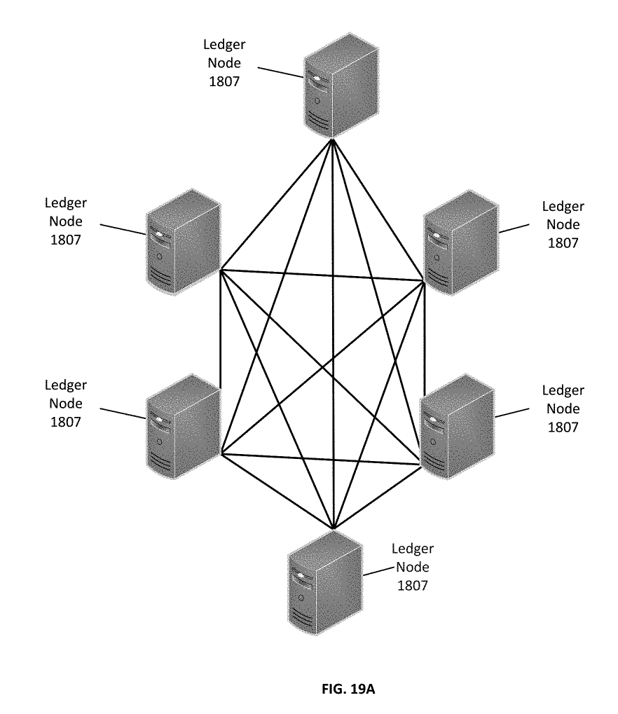

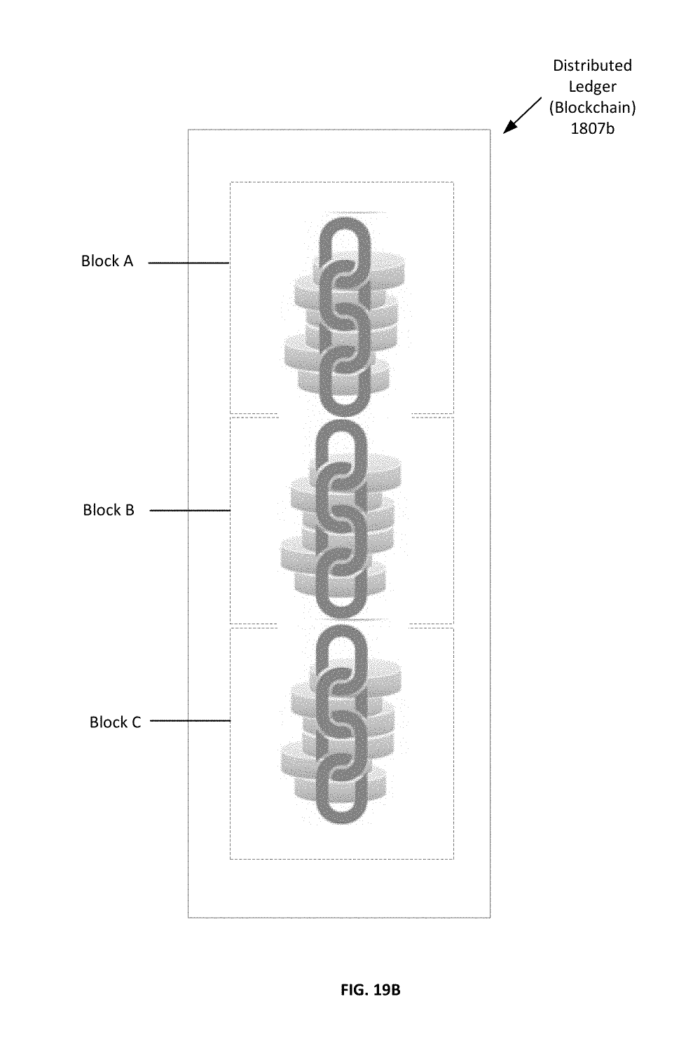

FIG. 19A illustrates an embodiment of a network of ledger nodes 1807 that are configured to manage and store transaction data on the distributed ledger 1807b. In one embodiment, all of the ledger nodes 1807 can store a copy of the distributed ledger 1807b, which includes block data for a sequence of blocks organized a blockchain formed over time. The block data can include transaction data that is aggregated and included as part of a new block that is added to the blockchain. The ledger nodes 1807 can store portions of the blockchain 1807b or the complete blockchain 1807b. For example, some nodes might store data for the entire blockchain, while other nodes might store data for only certain transactions, such as the calculated recommendation weights. Each ledger node 1807 (and possibly the wallet functionality 1802 and the protocol network node(s) 1805) can include functionality that can validate each block of the blockchain as well as the transaction(s) in a given block.

Some of the ledger nodes 1807 can be considered “miner” nodes that aggregate transactions and create a new block for addition to the blockchain. A miner node might perform some operations that easily verified by other ledger nodes 1807. Such operations can be intentionally both complex (to avoid non-authorized nodes from easily creating improper blocks) and dependent on the data of the included transactions (so that a non-authorized node cannot perform the complex operation ahead of time). Multiple miner nodes can possibly compete to perform the necessary work in creating the new block, which is referred to as a “proof-of-work” mining. Alternatively, the miner node for the new block can be selected based on its wealth or stake in the network (referred to as a “proof-of-stake work” mining or forging). Such selection may be made in a deterministic manner. After mining the new block, the miner node disseminates the new block to other ledger nodes, which validate the new block and transactions embedded therein. If the other ledger nodes succeed in validating the new block, the other ledger nodes add the new block to the blockchain and propagates the new block to other ledger nodes, thereby committing the new block to the blockchain. Once committed to the blockchain, the transaction is immutable and cannot be deleted. It is noted that some transactions (such as a recommendation transaction) may be modified or reversed by a subsequent transaction, but it cannot be deleted.

FIG. 19B shows a schematic illustration of the distributed ledger 1807b implemented as a blockchain. In embodiments, valid blocks are added to the blockchain by a consensus of the ledger nodes 1807 in the network. The blockchain may include an ordered list of validated blocks (for example, three shown), each of which groups together multiple transactions. Each block can be labeled with a timestamp and a “fingerprint” of a respective previous block. The fingerprint may be a hash of the previous block to form the link of blocks in the blockchain. Additionally, each block can include a group of transactions. Such transactions can include one or more transactions that add or update profile data of a respective account holder. It will be noted that the aforementioned sidechain may have the structure of the blockchain described herein.

In view of the foregoing, it will be appreciated that the network 1800 described in accordance with this disclosure is decentralized and can be open to any party. By being decentralized, the network liberates data from centralized-proprietary services and silos. The distributed ledger technology makes profile data of account holders accessible across various applications and platforms. Moreover, since the data stored on the distributed ledger 1807b is immutable, and can be accessed publicly, the information stored there can be checked for its veracity and manipulation by account holders.

In embodiments, certain participants (such as account holders, storer(s) and retriever(s)) can possibly use the social network for free (without payment to social network). In this case, tokens can be automatically created by the social network to reward the ledger nodes for their computational and bookkeeping functions. In embodiments, a token reward of value (Rt) can be paid to the mining node that integrates a transaction (t) into the distributed ledger. For example, the token reward of value (Rt) can be determined by the type of request, a global variable set by the governance of the network, and the quality score of the storer node that made the request as follows:

Rₜ=UₐVQₛ, Eqn. (17)

where Rₜ is the token reward of value the mining ledger node earns for a given transaction;

a is a type of transaction; for example, creating a bio, adding a recommendation, retracting a verifications, etc.;

Uₐ is the median number of computing units estimated to be used by the transaction type a; some transactions are expected to use significantly more computing resources than others; for example, adding an experience is much simpler than adding a recommendation, as the latter is likely to trigger the recalculation of the recommendation weights of multiple recommendations and persons; the number of units for each type of transaction can be adjusted by the governance of the network;

V is a variable set by the governance of the network; it is meant to control the number of ledger nodes in the network and the speed at which requests are processed; increasing V increases the rewards received by the mining ledger nodes, thus attracting more ledger nodes and making the network faster; and decreasing V discourages ledger nodes from participating in mining and makes the network slower; given that the mining ledger nodes are rewarded with tokens created on demand, increasing V speeds up the dilution of tokens, while decreasing it slows down dilution;

s is the storer making the request; and

Qₛ is the quality score of the storer making the request.

To avoid storer node(s) from spamming the network, creating unnecessary rewards for the mining ledger nodes, or performing denial-of-service attacks, mining ledger nodes are encouraged to prioritize requests submitted by storer nodes with a good quality score and deprioritize or block requests submitted by storer nodes with a poor-quality score. The quality score for each storer node can be dynamically set with votes following the governance of network. The protocol can dynamically limit the number of requests for new storer nodes, and subsequently relax that number as their quality score increases.

In embodiments, incentives, such as payments or other rewards, are not provided to the protocol nodes for the functionality that they provide to the network as described herein.

In other embodiments, incentives, such as payments or other rewards, can be provided to the protocol nodes from other nodes of the network for the functionality that the protocol nodes.

In still other embodiments, network nodes can possibly receive incentives, as payments or other rewards, for interacting with other nodes, or possibly present incentives, as payments or other rewards, for interacting with other nodes.

In embodiments, the social network can be implemented by a combination of two distributed ledgers (e.g., blockchains), which include:

The Data Ledger (Blockchain). This public ledger hosts most of the user profile data, including biographical information, recommendations, and verifications, but excludes the tokens that are rewarded to the ledger nodes that store the data in the Data Ledger.

The Token Ledger (Blockchain). This public ledger is used to create, buy, and sell the tokens that are rewarded to the ledger nodes that store the data in the Data Ledger. A smart contract on the Token Ledger can be configured to create new tokens to reward the ledger nodes for their work in storing data on the Data Ledger. To determine the appropriate token reward, the smart contract can pull information from the Data Ledger using oracles. The Token Ledger can be managed using an existing network, such as Ethereum, thus enabling reward tokens to enjoy additional liquidity and meet common standards, such as ERC20 or similar token standard. In this scenario, the mining ledger nodes of the Data Ledger can operate to trigger the smart contract that rewards them with newly minted tokens.

In other embodiments, all or part of the functionality of a particular participant (or node-type) can be combined or integrated with all or part of the functionality of one or more other participants (or node types). For example, all or part of the wallet functionality can be combined with the all or part of the functionality of the storer node(s) and/or retriever node(s) as described herein. In another example, all or part of the functionality of the storer node(s) and/or retriever node(s) can be combined with all or part of the functionality of the protocol network node(s) as herein. In still another example, all or part of the functionality of the protocol network node(s) can be combined with all or part of the functionality of the ledger nodes as described herein.

Certain embodiments as described herein can include logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules may provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program may be written in any form of programming language, including compiled or interpreted languages, and it may be deployed in any form, including as a stand-alone program or as a module, subroutine, or other unit suitable for use in a computing environment. A computer program may be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations may also be performed by, and apparatus of example embodiments may be implemented as, special purpose logic circuitry, e.g., a field programmable gate array (FPGA) or an application-specific integrated circuit (ASIC).

The computing system may include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

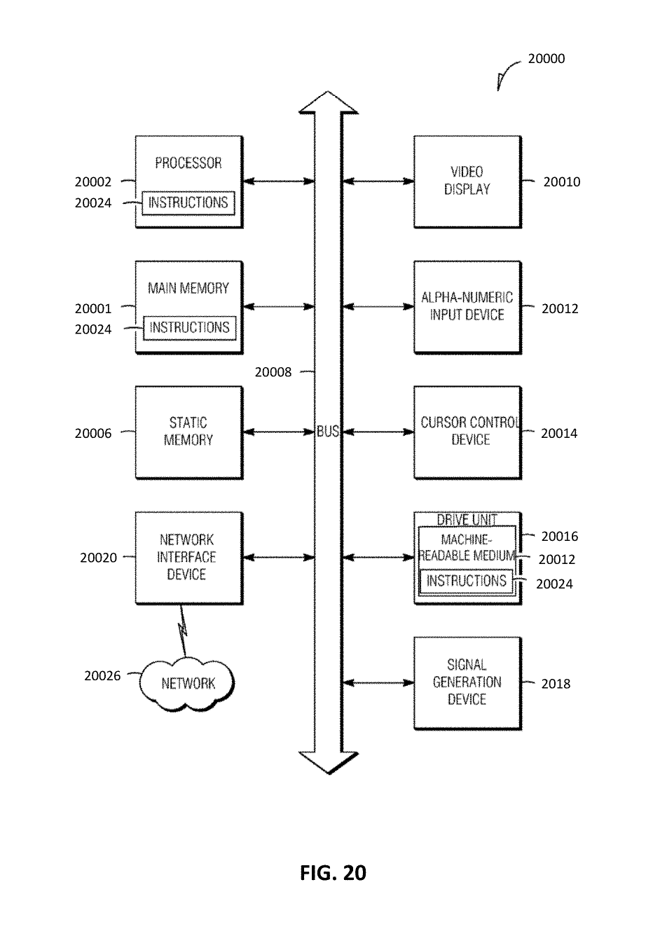

FIG. 20 shows a diagrammatic representation of a machine in the example form of a computer system 20000 within which a set of instructions for causing the machine to perform any one or more of the methods, processes, operations, or methodologies discussed herein may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a Personal Computer (PC), a tablet PC, a Personal Digital Assistant (PDA), a cellular telephone or smartphone, a Web appliance, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Example embodiments may also be practiced in distributed system environments where local and remote computer systems which that are linked (e.g., either by hardwired, wireless, or a combination of hardwired and wireless connections) through a network, both perform tasks. In a distributed system environment, program modules may be located in both local and remote memory-storage devices (see below).

The example computer system 20000 includes a processor 20002 (e.g., a Central Processing Unit (CPU), a Graphics Processing Unit (GPU) or both), a main memory 20001 and a static memory 20006, which communicate with each other via a bus 20008. The computer system 20000 may further include a video display unit 20010 (e.g., a Liquid Crystal Display (LCD) or a Cathode Ray Tube (CRT)). The computer system 20000 also includes an alphanumeric input device 20012 (e.g., a keyboard), a User Interface (UI) cursor controller 20014 (e.g., a mouse), a disk drive unit 20016, a signal generation device 20018 (e.g., a speaker) and a network interface device 20020 (e.g., a transmitter).

The disk drive unit 20016 includes a machine-readable medium 20022 on which is stored one or more sets of instructions 20024 and data structures (e.g., software) embodying or used by one or more of the methodologies or functions illustrated herein. The software may also reside, completely or at least partially, within the main memory 20001 and/or within the processor 20002 during execution thereof by the computer system 20000, the main memory 20001 and the processor 20002 also constituting machine-readable media.

The instructions 20024 may further be transmitted or received over a network 20026 via the network interface device 20020 using any one of a number of well-known transfer protocols (e.g., HTTP).

The term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding, or carrying a set of instructions for execution by the machine and that cause the machine to perform any of the one or more of the methodologies illustrated herein. The term “machine-readable medium” shall accordingly be taken to include, but not be limited to, solid-state memories, and optical and magnetic medium.

Method embodiments illustrated herein may be computer-implemented. Some embodiments may include computer-readable media encoded with a computer program (e.g., software), which includes instructions operable to cause an electronic device to perform methods of various embodiments. A software implementation (or computer-implemented method) may include microcode, assembly language code, or a higher-level language code, which further may include computer readable instructions for performing various methods. The code may form portions of computer program products. Further, the code may be tangibly stored on one or more volatile or non-volatile computer-readable media during execution or at other times. These computer-readable media may include, but are not limited to, hard disks, removable magnetic disks, removable optical disks (e.g., compact disks and digital video disks), magnetic cassettes, memory cards or sticks, Random Access Memories (RAMs), Read Only Memories (ROMs), and the like.

The above detailed description includes references to the accompanying drawings, which form a part of the detailed description. The drawings show, by way of illustration, specific embodiments in which the invention may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a non-exclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment, and it is contemplated that such embodiments may be combined with each other in various combinations or permutations. The scope of the invention should be determined with reference to the appended claims, along with the full scope of equivalents to which such claims are entitled.

What is claimed is:

1. A computer-implemented method involving a plurality of users of a social network, comprising:
interacting with the plurality of users to generate recommendations, wherein each recommendation is made by a first user and recommends a second user;
storing data representing the recommendations;
calculating total recommendation weights corresponding to the plurality of users as well as recommendation weights corresponding to the recommendations; and
storing data representing the total recommendation weights corresponding to the plurality of users and data representing the recommendation weights corresponding to the recommendations.

2. A computer-implemented method according to claim 1, further comprising:
displaying data representing the total recommendation weight corresponding to a given user in conjunction with displaying at least part of a profile of the given user.

3. A computer-implemented method according to claim 1, further comprising:
displaying a representation of the given recommendation and data representing the recommendation weight corresponding to the given recommendation.

4. A computer-implemented method according to claim 3, further comprising:
the representation of the given recommendation and the data representing the recommendation weight corresponding to the given recommendation are displayed in conjunction with displaying at least part of a profile of the second user of the given recommendation; and/or
the representation of the given recommendation and the data representing the recommendation weight corresponding to the given recommendation are displayed in conjunction with displaying at least part of a profile of the first user of the given recommendation.

5. A computer-implemented method according to claim 1, wherein:
the recommendation weight for a given recommendation is based on the total recommendation weight of the first user of the given recommendation.

6. A computer-implemented method according to claim 1, wherein:
the recommendation weight for a given recommendation is based on a longevity parameter that characterizes time duration of the relation between the first user and second user of the given recommendation.

7. A computer-implemented method according to claim 1, wherein:
the recommendation weight for a given recommendation is based on a factor dictated by type of relation between the first user and second user of the given recommendation.

8. A computer-implemented method according to claim 1, wherein:
the recommendation weight for a given recommendation is normalized by a sum corresponding to the total number of recommendations made by the first user of the given recommendation.

9. A computer-implemented method according to claim 1, wherein the recommendation weight for a given recommendation is of the form:
$${w}_{r} ( X 1 , Y ) = \frac{t ( X 1 ) {L}_{X 1 , Y} {F}_{X 1 , Y}}{{\sum }_{i = 0}^{n} {( {L}_{i} {F}_{i} )}_{X 1}}$$
where X1 denotes the user giving the given recommendation and Y denotes the user receiving the given recommendation,
t(X1) is the total recommendation weight of X1;
L_{X1,Y} is a longevity factor that depends on the time duration of the relation between X1 and Y;
F_{X1,Y} is a factor associated with the type of relation between X1 and Y; and
the summation Σᵢ₌₀ⁿ=(LᵢFᵢ)_{X1} corresponds to the total number of recommendations made by X1 of the given recommendation and adds the multiplication product of the longevity factors and relation type factors for all the recommendations given by X1.

10. A computer-implemented method according to claim 1, wherein:
the total recommendation weight for a given user is calculated from the sum of the recommendation weights for all recommendations received by the given user.

11. A computer-implemented method according to claim 10, wherein the total recommendation weight for a given user is of the form:
t(Y)=β(X1, Y)+ . . . wᵣ(Xn,Y))
where Y is the given user recommended by a number of other users denoted X1 . . . Xn;
η is a damping factor constant in the interval [0,1], which limits the extent in which the User Y's total recommendation weight will be inherited by its recommendations; and
the sum (wᵣ(X1, Y)+ . . . wᵣ(Xn, Y) represents the sum of all the recommendations weights for the recommendations that the given User Y has received.

12. A computer-implemented method according to claim 1, wherein:
the recommendation weight corresponding to a given recommendation provides a measure of trustworthiness of the given recommendation; and
the total recommendation weight corresponding to a given user provides a measure of trustworthiness of the given user.

13. A computer-implemented method according to claim 1, further comprising:
as part of generating the recommendations, interacting with the first user of a given recommendation to specify a set of strengths of the second user that are associated with the given recommendation;
storing data representing the set of strengths of the second user that are associated with the given recommendation;
calculating per-strength recommendation weights for the set of strengths of the second user that are associated with the given recommendation; and
storing data representing the per-strength recommendation weights for the set of strengths of the second user that are associated with the given recommendation.

14. A computer-implemented method according to claim 13, wherein:
the per-strength recommendation weights for the set of strengths of the second user that are associated with the given recommendation are calculating by distributing the recommendation weight corresponding to the given recommendation.

15. A computer-implemented method according to claim 13, further comprising:
calculating a total per-strength recommendation weight for at least one particular strength of a given user by summing the per-strength recommendation weights for the particular strength over all recommendations received by the given user; and
storing data representing the total per-strength recommendation weight for the at least one particular strength of the given user.

16. A computer-implemented method according to claim 15, further comprising:
using data representing the total per-strength recommendation weight for at least one particular strength of users to rank users that match a particular job posting or users that are interested in a particular job posting.

17. A computer-implemented method according to claim 1, further comprising:
as part of generating the recommendations, interacting with the first user of a given recommendation to specify a set of experiences of the second user that are associated with the given recommendation;
storing data representing the set of experiences of the second user that are associated with the given recommendation;
calculating per-experience recommendation weights for the set of experiences of the second user that are associated with the given recommendation; and
storing data representing the per-experience recommendation weights for the set of experiences of the second user that are associated with the given recommendation.

18. A computer-implemented method according to claim 17, wherein:
the per-experience recommendation weights for the set of experiences of the second user that are associated with the given recommendation are calculating by distributing the recommendation weight corresponding to the given recommendation.

19. A computer-implemented method according to claim 17, further comprising:
calculating a total per-experience recommendation weight for at least one particular experience of a given user by summing the per-experience recommendation weights for the particular experience over all recommendations received by the given user; and
storing data representing the total per-experience recommendation weight for the at least one particular experience of the given user.

20. A computer-implemented method according to claim 17, further comprising:
using data representing the total per-experience weight for at least one particular experience of users to rank users that match a particular job posting or users that are interested in a particular job posting.

21. A computer-implemented method according to claim 1, further comprising:
using data representing the total recommendation weights of users to rank users that match a particular job posting or users that are interested in a particular job posting.

22. A computer-implemented method according to claim 1, wherein:
user profile data for the plurality of users of the social network is stored in a distributed ledger.

23. A computer-implemented method according to claim 22, wherein:
the user profile data stored in the distributed ledger includes the data representing the total recommendation weights corresponding to the plurality of users and the data representing the recommendation weights corresponding to the recommendations.

24. A computer-implemented method according to claim 22, wherein:
the user profile data stored in the distributed ledger is based upon requests that include digital signatures derived from private encryption keys of the users; and
each request is validating by verifying the digital signature included in the request against a public encryption key of the corresponding user (where such public encryption key is preferably stored as publicly available data in the distributed ledger).

25. A computer-implemented method according to claim 24, wherein:
the calculation of total recommendation weights corresponding to the plurality of users as well as the calculation of the recommendation weights corresponding to the recommendations is performed by at least one node of the social network in response to a request that adds or updates a recommendation for a user.

26. A computer-implemented method according to claim 25, wherein:
the at least one node is configured to perform a set of actions that adds or updates user profile data of a user in response to requests supplied thereto.

27. A computer-implemented method according to claim 24, wherein:
wallet functionality stores a private encryption key for each respective user and uses the private encryption key to digitally sign requests issued by the user to add or update user profile data of the user.

28. A social network system comprising:
at least one computer processor configured to include
at least one module configured to interact with a plurality of users of the social network to generate recommendations, wherein each recommendation is made by a first user and recommends a second user, and
at least one module configured to calculate total recommendation weights corresponding to the plurality of users as well as recommendation weights corresponding to the recommendations; and
data storage configured to store data representing the total recommendation weights corresponding to the plurality of users and data representing the recommendation weights corresponding to the recommendations.

29. A social network system according to claim 28, wherein:
the at least one computer processor is further configured to include at least one module configured to present for display data representing the total recommendation weight corresponding to a given user in conjunction with displaying at least part of a profile of the given user.

30. A social network system according to claim 28, wherein:
the at least one computer processor is further configured to include at least one module configured to present for display a representation of the given recommendation and data representing the recommendation weight corresponding to the given recommendation.

31. A social network system according to claim 28, further comprising:
a network of ledger nodes that maintain a distributed ledger, wherein user profile data for the plurality of users of the social network is stored in the distributed ledger.

32. A social network system according to claim 31, wherein:
the user profile data stored in the distributed ledger includes the data representing the total recommendation weights corresponding to the plurality of users and the data representing the recommendation weights corresponding to the recommendations.

33. A social network system according to claim 31, wherein:
the user profile data stored in the distributed ledger is based upon requests that include digital signatures derived from private encryption keys of the users; and
each request is validating by verifying the digital signature included in the request against a public encryption key of the corresponding user (where such public encryption key is preferably stored as publicly available data in the distributed ledger).

34. A social network system according to claim 31, further comprising:
at least one node that performs the calculation of total recommendation weights corresponding to the plurality of users as well as the calculation of the recommendation weights corresponding to the recommendations in response to a request that adds or updates a recommendation for a user.

35. A social network system according to claim 34, wherein:
the at least one node is configured to perform a set of actions that adds or updates user profile data of a user in response to requests supplied thereto.

36. A social network system according to claim 31, further comprising:
wallet functionality that is configured to store a private encryption key for each respective user and use the private encryption key to digitally sign requests issued by the user to add or update user profile data of the user.
